(19) United States
(12) Patent Application Publication
(10) Pub. No.: US 2017/0235049 A1
(43) Pub. Date: Aug. 17, 2017

(54) OPTICAL FIBER ASSEMBLY WITH ENHANCED FILTERING OF HIGHER-ORDER MODES

(71) Applicant: INSTITUT NATIONAL D'OPTIQUE, Québec (CA)

(72) Inventors: Marc DELADURANTAYE, Québec (CA); Claude PARÉ, Québec (CA); Pierre LAPERLE, Québec (CA)

(73) Assignee: INSTITUT NATIONAL D'OPTIQUE, Québec (CA)

(21) Appl. No.: 15/424,440

(22) Filed: Feb. 3, 2017

Related U.S. Application Data
(60) Provisional application No. 62/294,525, filed on Feb. 12, 2016.

(51) Int. Cl. G02B 6/14; G02B 6/44; G02F 1/01

(52) U.S. Cl. CPC G02B 6/14; G02F 1/0134; G02B 6/4457

(57) ABSTRACT

Optical fiber assemblies for filtering of higher-order modes include a winding support and an optical fiber wound along a winding path on the winding support. The optical fiber is configured to support a fundamental transverse mode and one or more higher-order transverse modes. The optical fiber has a longitudinal fiber axis, a core, a cladding surrounding the core, a transverse cross-section lacking circular symmetry, and a rotation imparted thereto about the longitudinal fiber axis. The rotation and winding of the optical fiber provide stronger attenuation of the one or more higher-order transverse modes as compared to the fundamental transverse mode. In some implementations, the winding path has a non-constant radius of curvature. In other implementations, the optical fiber has a diameter larger than 10 micrometers and at least one stress-applying part arranged in the cladding about the core. Methods perform higher-order-mode filtering.

### RELATED PATENT APPLICATION

The present application claims priority benefit of U.S. provisional patent application No. 62/294,525 filed on Feb. 12, 2016, the disclosure of which is incorporated herein by reference in its entirety.

### TECHNICAL FIELD

The general technical field relates to optical fibers and, in particular, to optical fibers in which higher-order modes can be effectively suppressed or attenuated to achieve substantially single-mode operation.

### BACKGROUND

Fiber lasers and amplifiers have been used as high-power pulsed and continuous-wave laser sources in a wide range of applications requiring or benefiting from high-quality and near diffraction-limited beams. Such applications can be found in fields such as medicine and surgery, scientific instrumentation, semiconductor device manufacturing, military technology, and precision material processing. One limitation to the development of fiber lasers and amplifiers emitting higher optical power levels and pulse energies is the generation of nonlinear optical effects, particularly stimulated Brillouin scattering (SBS), stimulated Raman scattering (SRS) and self-phase modulation. Large-mode-area (LMA) fibers are commonly used in high-power fiber lasers and amplifiers to avoid or reduce the detrimental effects of nonlinear phenomena. However, as the core area of an optical fiber is increased to enable higher optical powers, the fiber begins to support the propagation of higher-order transverse modes in addition to the fundamental mode. The presence of higher-order modes generally degrades the quality and pointing stability of the beam outputted by the fiber compared with the case where only the fundamental mode is propagating.

Various approaches have been developed to manage higher-order modes in optical fibers, but numerous challenges remain, particularly with increasing core sizes.

### SUMMARY

The present description generally relates to techniques for eliminating or at least reducing higher-order modes in optical fiber systems. More particularly, the present techniques provide optical fiber assemblies and methods for enhanced filtering of higher-order modes by differential bending losses. Implementations of the optical fiber assemblies include a winding support and an optical fiber wound along a winding path on the winding support. The optical fiber is configured to support a fundamental transverse mode and one or more higher-order transverse modes. The optical fiber has a transverse cross-section lacking circular symmetry and a rotation (e.g., a spin or a twist) imparted thereto about its longitudinal fiber axis. The rotation and winding of the optical fiber are such that they favor or promote attenuation of the one or more higher-order transverse modes while allowing propagation of the fundamental transverse mode. In some implementations, the higher-order modes can be sufficiently attenuated to achieve substantially single-mode operation. That is, in some implementations, it is possible to obtain an optical output beam formed essentially of the fundamental mode, even when the beam injected into the fiber excites several higher-order modes in addition to the fundamental mode. In some implementations, the fiber assembly provides enhanced filtering of the LP₁₁ mode group. More particularly, in some cases, both the even and the odd LP₁₁ modes can be effectively filtered.

In accordance with an aspect, there is provided an optical fiber assembly for higher-order-mode filtering. The optical fiber assembly includes:
a winding support; and
an optical fiber configured to support a fundamental transverse mode and one or more higher-order transverse modes, the optical fiber having a longitudinal fiber axis, a core, a cladding surrounding the core, a transverse cross-section having at least one characteristic lacking circular symmetry, and a rotation imparted thereto about the longitudinal fiber axis with a spatial repetition period, the optical fiber being wound on the winding support along a winding path having a non-constant radius of curvature, the rotation and winding of the optical fiber providing stronger attenuation of the one or more higher-order transverse modes as compared to the fundamental transverse mode.

In some implementations, the winding path includes a plurality of turns on the winding support, each one of the turns including at least one first segment having a first length and a first radius of curvature and at least one second segment having a second length and a second radius of curvature larger than the first radius of curvature, the second length being selected in accordance with the spatial repetition period. By way of example, the second length can be selected such that it is in a predetermined ratio to the spatial repetition period.

In some implementations, the winding path includes a plurality of turns on the winding support, each one of the turns having an obround shape consisting of two semi-circular segments connected at respective endpoints thereof by two straight segments parallel to each other. The straight segments have a length selected in accordance with the spatial repetition period. By way of example, the second length can be selected such that it is in a predetermined ratio to the spatial repetition period.

In some implementations, a ratio of the length of the straight segments to the spatial repetition period is selected such that the one or more higher-order transverse modes undergo an odd integer number of 90° rotations upon propagation along each straight segment. In some of these implementations, the ratio of the spatial repetition period to the length of the straight segments is such that both the even and the odd LP₁₁ modes experience an odd integer number of 90° rotations during their propagation along each straight segment. In such a case, each straight segment is therefore configured to convert the even LP₁₁ mode into the odd LP₁₁ mode, and vice versa.

In some implementations, the rotation imparted to the optical fiber has a constant spatial repetition period, or pitch. However, in other implementations, the spatial repetition period pitch varies, periodically or not, along the fiber length. In some implementations, the spatial repetition period ranges from 1 centimeter (cm) to 50 cm, for example from a few cm to a few tens of cm.

In some implementations, the rotation is imparted to the optical fiber along the entire length thereof. In other implementations, the rotation is imparted to the optical fiber along a partial length thereof.

In some implementations, the core has a diameter larger than 30 micrometers (μm). For example, the optical fiber can be an LMA fiber, possibly an active LMA fiber, having a core diameter larger than 30 μm.

In some implementations, the lack of circular symmetry of the transverse cross-section of the optical fiber results from the optical fiber being a polarization-maintaining (PM) fiber including at least one stress-applying part (SAP) enclosed within the cladding and arranged about the core. In some of these implementations, the optical fiber has an unspun polarization beat length shorter than the spatial repetition period. In other implementations, the optical fiber is another type of PM fiber. In yet other implementations, the optical fiber is not a PM fiber.

In some implementations, the winding path defines a three-dimensional helical trajectory.

In some implementations, the winding path defines a two-dimensional spiral trajectory.

In some implementations, the rotation imparted to the optical fiber results from a permanent spin impressed on the optical fiber. In such implementations, the optical fiber can be referred to as a spun optical fiber. The spin can be impressed on the fiber during the drawing process, resulting in a permanent rotational deformation of the fiber after cooling. In other implementations, the optical fiber is a twisted fiber rather than a spun fiber. The twisted fiber state can be achieved by applying an elastic torsion to the fiber during the operation of the optical fiber assembly and, thus, while the fiber is wound onto the winding support.

In some implementations, the core has an elliptical transverse cross-section with a major cross-sectional axis and a minor cross-sectional axis, a ratio of the minor cross-sectional axis to the major cross-sectional axis being greater than 0.95 and less than 1.

In some implementations, the lack of circular symmetry of the transverse cross-section of the optical fiber results from the core being off-centered with respect to the longitudinal fiber axis.

In some implementations, the lack of circular symmetry of the transverse cross-section of the optical fiber results from the cladding including an inner cladding layer having a non-circular transverse cross-section, for example an elliptical transverse cross-section.

In some implementations, the fundamental transverse mode consists of an LP₀₁ mode and the one or more higher-order transverse modes include LP₁₁ modes.

In some implementations, non-limiting exemplary shapes for the winding path having a non-constant radius of curvature include ellipses, ovals, polygons, polygons with rounded corners (e.g., squares and rectangles with rounded corners), spirals with an outwardly increasing radius, circular segments having different radii of curvature, circular segments having the same radius but different centers (e.g., a figure-of-eight shape with two spaced-apart parallel winding axes), combinations of straight and curved segments, and the like.

In accordance with another aspect, there is provided an optical fiber assembly for higher-order-mode filtering. The optical fiber assembly includes:
a winding support; and
an optical fiber configured to support a fundamental transverse mode and one or more higher-order transverse modes, the optical fiber having a longitudinal fiber axis, a core having a diameter larger than 10 μm, a cladding surrounding the core, at least one stress-applying part enclosed within the cladding and arranged about the core, and a rotation imparted thereto about the longitudinal fiber axis with a spatial repetition period, the optical fiber being wound on the winding support along a winding path, the rotation and winding of the optical fiber providing stronger attenuation of the one or more higher-order transverse modes as compared to the fundamental transverse mode.

In some implementations, the at least one stress-applying part consists of a pair of stress-applying parts extending along diametrically opposed helical paths about the core.

In some implementations, the spatial repetition period ranges from 1 cm to 50 cm.

In some implementations, the optical fiber has an unspun polarization beat length shorter than the spatial repetition period.

In some implementations, the winding path defines a three-dimensional helical trajectory.

In some implementations, the winding path defines a two-dimensional spiral trajectory.

In some implementations, the rotation imparted to the optical fiber results from a permanent spin impressed on the optical fiber. In other implementations, the rotation imparted to the optical fiber results from a non-permanent elastic torsion rotation applied to the fiber in operation of the optical fiber assembly in a way such that the fiber will return to its original state after removing the torsional torque. In such implementations, the optical fiber can be referred to as a twisted optical fiber.

In some implementations, the core has an elliptical transverse cross-section with a major cross-sectional axis and a minor cross-sectional axis, a ratio of the minor cross-sectional axis to the major cross-sectional axis being greater than 0.95 and less than 1.

In some implementations, the winding path has a constant radius of curvature. In other implementations, the winding path has a non-constant radius of curvature.

In accordance with another aspect, there is provided a method for higher-order-mode filtering. The method includes:
providing an optical fiber configured to support a fundamental transverse mode and one or more higher-order transverse modes, the optical fiber having a longitudinal fiber axis, a core, a cladding surrounding the core, a transverse cross-section having at least one characteristic lacking circular symmetry, and a rotation imparted about the longitudinal fiber axis with a spatial repetition period, the optical fiber being wound along a winding path having a non-constant radius of curvature; and
injecting a light signal into the optical fiber for propagation thereinside in the fundamental transverse mode and the one or more higher-order transverse modes, the rotation and winding of the optical fiber providing stronger attenuation of the one or more higher-order transverse modes as compared to the fundamental transverse mode as the light signal propagates in the optical fiber.

In some implementations, the winding path includes a plurality of turns, each one of the turns having at least one first segment having a first length and a first radius of curvature and at least one second segment having a second length and a second radius of curvature larger than the first radius of curvature. In such implementations, the method further includes selecting the second length in accordance with the spatial repetition period. By way of example, the second length can be selected such that it is in a predetermined ratio to the spatial repetition period.

In some implementations, the winding path includes a plurality of turns, each one of the turns having an obround shape consisting of two semi-circular segments connected at respective endpoints thereof by two straight segments parallel to each other. In such implementations, the method further includes selecting a length of the straight segments in accordance with the spatial repetition period. By way of example, the second length can be selected such that it is in a predetermined ratio to the spatial repetition period.

In some implementations, the selecting step includes determining a ratio of the length of the straight segments to the spatial repetition period that causes the one or more higher-order transverse modes to undergo an odd integer number of 90° rotations upon propagation along each straight segment.

In some implementations, the core has a diameter larger than 30 μm.

In some implementations, the optical fiber further includes at least one stress-applying part enclosed within the cladding and arranged about the core. In some of these implementations, the optical fiber has an unspun polarization beat length shorter than the spatial repetition period.

In some implementations, the rotation imparted to the optical fiber results from a permanent spin impressed on the optical fiber. In other implementations, the rotation imparted to the optical fiber results from a non-permanent twist applied to the optical fiber during operation of the optical fiber assembly.

In some implementations, the core has an elliptical transverse cross-section with a major cross-sectional axis and a minor cross-sectional axis, a ratio of the minor cross-sectional axis to the major cross-sectional axis being greater than 0.95 and less than 1.

In accordance with another aspect, there is provided a method for higher-order-mode filtering. The method includes:
providing an optical fiber wound along a winding path and configured to support a fundamental transverse mode and one or more higher-order transverse modes, the optical fiber having a longitudinal fiber axis, a core having a diameter larger than 10 μm, a cladding surrounding the core, at least one stress-applying part enclosed within the cladding and arranged about the core, and a rotation imparted about the longitudinal fiber axis with a spatial repetition period; and
injecting a light signal into the optical fiber for propagation thereinside in the fundamental transverse mode and the one or more higher-order transverse modes, the rotation and winding of the optical fiber providing stronger attenuation of the one or more higher-order transverse modes as compared to the fundamental transverse mode as the light signal propagates in the optical fiber.

In some implementations, the at least one stress-applying part consists of a pair of stress-applying parts extending in the cladding along diametrically opposed helical paths about the core.

In some implementations, the spatial repetition period ranges from 1 cm to 50 cm.

In some implementations, the optical fiber has an unspun polarization beat length shorter than the spatial repetition period.

In some implementations, the rotation imparted to the optical fiber results from a permanent spin impressed on the optical fiber. In other implementations, the rotation imparted to the optical fiber results from a non-permanent twist applied to the optical fiber during operation of the optical fiber assembly.

In some implementations, the core has an elliptical transverse cross-section with a major cross-sectional axis and a minor cross-sectional axis, a ratio of the minor cross-sectional axis to the major cross-sectional axis being greater than 0.95 and less than 1.

In some implementations, the fiber assembly can include:
an optical fiber having a longitudinal fiber axis, the optical fiber having a spin about the longitudinal axis, the spin being characterized by a spin pitch, the optical fiber defining a fundamental transverse mode and a set of higher-order transverse modes, the optical fiber also including:
   an input end for receiving an input optical beam;
   an output end for radiating an optical output beam; and
   a core extending along the longitudinal axis; and
a winding support for coiling a portion of the optical fiber over a number of turns, the winding support being configured so that each turn of the optical fiber defines a figure, the figure including at least one first portion having a first length and a first range of radii of curvature, and at least one second portion having a second length and a second range of radii of curvature, the second range of radii of curvature being different and involving substantially larger radii than the first range of radii of curvature;
wherein a ratio of the spin pitch of the optical fiber to the second length of the at least one second portion of the figure is selected to enhance a filtering action of the set of higher-order transverse modes, the filtering action favoring that the optical output beam be composed mostly of the fundamental transverse mode of the optical fiber.

In accordance with another aspect, there is provided a kit for forming an optical fiber assembly providing filtering of higher-order modes by differential bending losses. The kit includes a winding support and an optical fiber configured for being wound along a winding path on the winding support. The optical fiber is configured to support a fundamental transverse mode and one or more higher-order transverse modes. The optical fiber has a longitudinal fiber axis, a core, a cladding surrounding the core, a transverse cross-section lacking circular symmetry, and a rotation imparted thereto about the longitudinal fiber axis. The rotation and winding of the optical fiber are such that they favor attenuation of the one or more higher-order transverse modes while allowing propagation of the fundamental transverse mode.

In accordance with another aspect, there is provided an optical fiber as disclosed herein for use in combination with a winding support to provide higher-order-mode filtering.

In accordance with another aspect, there is provided a use of an optical fiber assembly as disclosed herein for filtering higher-order modes from an optical signal propagating along an optical fiber of the optical fiber assembly.

Other features and advantages of the present description will become more apparent upon reading of the following non-restrictive description of specific embodiments thereof, given by way of example only with reference to the accompanying drawings.

### BRIEF DESCRIPTION OF THE DRAWINGS

FIG. 1 is a schematic representation of an optical fiber assembly in accordance with an exemplary embodiment, in which the optical fiber is a spun PM fiber wound along a non-circular winding path.

FIG. 2 is a schematic representation of the optical fiber of the fiber assembly of FIG. 1. The optical fiber is depicted in an unwound configuration to better illustrate the spin impressed thereon.

FIG. 3A is a schematic representation of a technique for fabricating a spun optical fiber, involving rotating the preform as the fiber is drawn (preform spinning technique). FIG. 3B is a schematic representation of another technique for fabricating a spun optical fiber, involving rotating the fiber during the drawing process (fiber spinning technique). FIG. 3C is a schematic representation of a technique for obtaining a twisted fiber, involving the application of an elastic torsion to a post-drawn fiber.

FIG. 4 is a schematic representation of an optical fiber assembly in accordance with another exemplary embodiment, wherein the winding path defines a two-dimensional spiral trajectory on the winding support.

FIGS. 5A and 5B illustrate two different possible orientations of the line joining the centers of the SAPs of a conventional unspun PANDA-type PM fiber wound into a circular coil. The line is perpendicular to the plane of bending XZ in FIG. 5A and parallel to the plane of bending XZ in FIG. 5B.

FIGS. 6A and 6B show cross-sectional views of the conventional unspun fiber of FIGS. 5A and 5B, respectively.

FIGS. 7A and 7B show the refractive index profile of the fiber with respect to that of the cladding along the X axis for the fiber orientations of FIGS. 5A and 5B, respectively.

FIG. 8A shows the optical irradiance distribution of the even LP₁₁ mode in a conventional fiber corresponding to those of FIGS. 5A and 5B, but in a straight (i.e., unbent and uncoiled) state. FIG. 8B is the same as FIG. 8A, but for the odd LP₁₁ mode. The operating wavelength is 1060 nanometers (nm).

FIGS. 9A and 9B illustrate numerically calculated bending loss curves plotted as a function of bending radius for the even LP₁₁ mode (solid curve) and the odd LP₁₁ mode (dashed curve) in the fiber orientation of FIGS. 5A and 5B, respectively. The core diameter is 18 μm and the operating wavelength is 1060 nm.

FIG. 10 is a numerically calculated bending loss curve plotted as a function of propagation distance in a spun PANDA-type PM LMA fiber, the fiber being wound into a circular coil using a cylindrical mandrel. Light is launched into the fiber in the even LP₁₁ mode, that is, in the mode that extends predominantly in the bending plane. The numerical simulations were performed using an operating wavelength of 1060 nm and a spin pitch of 40 cm. The core diameter is 18 μm.

FIGS. 11A to 11F are top plan views of different possible configurations for the winding surface of the winding support, in accordance with exemplary other embodiments of the optical fiber assembly. The winding surfaces define different non-circular shapes for the winding path of the coiled optical fiber: obround (FIG. 11A); ellipse (FIG. 11B); square with rounded corners (FIG. 11C); rectangle with rounded corners (FIG. 11D); figure of eight (FIG. 11E); and circle (FIG. 11F).

FIG. 12A is a numerical calculation of the normalized mode power of the fundamental mode LP₀₁, the even LP₁₁ mode and the odd LP₁₁ mode plotted as a function of propagation distance in a spun non-PM passive fiber coiled along a circular winding path having a bending radius of 5.5 cm. FIG. 12B is a numerical calculation of the normalized mode power of the fundamental mode LP₀₁, the even LP₁₁ mode and the odd LP₁₁ mode plotted as a function of propagation distance in a spun non-PM passive fiber coiled along an obround non-circular winding path for which the length of the straight segments is 5 cm and the bending radius of the semicircular segments is 5.5 cm. FIG. 12C shows numerically calculated total optical power curves normalized to input optical power plotted as a function of propagation distance for the circular winding path of FIG. 12A (dashed line) and the obround non-circular winding path (solid line) of FIG. 12B. FIG. 12D shows numerically calculated bending loss curves plotted as a function of propagation distance for the circular winding path of FIG. 12A (dashed line) and the obround non-circular winding path of FIG. 12B (solid line). The numerical simulations were performed using an operating wavelength of 1060 nm and a spin pitch of 20 cm.

FIGS. 13A and 13B are numerically calculated total optical power curves (FIG. 13A) and bending loss curves (FIG. 13B), each plotted as a function of propagation distance in a spun PM passive fiber coiled along an obround non-circular winding path (solid lines; length of straight segments: 5 cm, bending radius of semicircular segments: 5.5 cm) and a circular winding path (dashed lines; bending radius: 5.5 cm). The numerical simulations were performed using an operating wavelength of 1060 nm and a spin pitch of 20 cm.

FIG. 14 is a schematic representation of an optical fiber assembly in accordance with another exemplary embodiment, in which the optical fiber is a spun PM fiber wound along a circular winding path.

FIG. 15 is a schematic representation of an optical fiber assembly in accordance with another exemplary embodiment, in which the optical fiber is a spun PM fiber wound along a circular winding path and having an elliptical core. The ellipticity of the core has been exaggerated for the sake of clarity.

FIG. 16 is a schematic representation of an optical fiber assembly in accordance with another exemplary embodiment, in which the optical fiber is a spun non-PM fiber wound along a non-circular winding path and having an elliptical core. It is noted that the ellipticity of the core has been exaggerated for the sake of clarity.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The present description generally relates to techniques that can enhance the rejection or attenuation of unwanted higher-order modes present in optical fiber systems.

In accordance with an aspect, the present description discloses optical fiber assemblies that can eliminate or at least reduce higher-order modes from an optical signal propagating along an optical fiber, while ensuring that the fundamental mode of the optical signal remains unchanged or at least substantially unaltered. Therefore, in some implementations, it is possible to obtain, at the output end of the optical fiber, an output beam formed essentially of the fundamental transverse mode of the fiber (which typically has a Gaussian profile), even when the input beam launched into the fiber at the input end excites either a few or several higher-order transverse modes. For brevity, the term “transverse” may, in some instances, be omitted when referring to the modes supported by an optical fiber.

As described in greater detail below, the optical fiber assemblies generally include a winding support and an optical fiber which is wound or coiled along a winding path on the winding support. The optical fiber can support the propagation of a fundamental transverse mode and a set of higher-order transverse modes. The optical fiber also has a rotation (e.g., a spin or a twist) imparted or applied thereto around its longitudinal axis. The parameters of the rotation imparted or applied to the fiber (e.g., the spatial repetition period of the rotation) and the configuration of the winding path followed by the optical fiber (e.g., the size and shape of the winding path) are provided or set in such a way as to enhance, favor or promote a filtering action of the higher-order modes, while substantially preserving the fundamental mode. In other words, the optical fiber assemblies disclosed herein can allow higher-order transverse modes to be attenuated more strongly that the fundamental transverse mode during propagation inside the wound optical fiber.

In accordance with another aspect, the present description also discloses methods for filtering higher-order modes propagating in an optical fiber. The methods generally include a step of providing an optical fiber assembly such as those described herein, which include an optical fiber wound along a winding path and having a rotation imparted or applied thereto around and along its longitudinal axis. The methods also generally include a step of injecting a light signal into the optical fiber for propagation thereinside in a fundamental transverse mode and one or more higher-order transverse modes. As the light signal propagates in the optical fiber, the rotation and winding parameters of the optical fiber provide stronger attenuation of the higher-order transverse modes as compared to the fundamental transverse mode.

In accordance with other aspects, there are provided a use of an optical fiber assembly as disclosed herein for filtering higher-order modes from an optical signal propagating along an optical fiber of the optical fiber assembly; an optical fiber as disclosed herein for use in combination with a winding support to provide higher-order-mode filtering; and a kit including a winding support and an optical fiber for forming an optical fiber assembly providing filtering of higher-order modes by differential bending losses.

The present techniques may be useful in various applications where it is desired or necessary to provide enhanced filtering of higher-order modes in a manner that allows scaling fiber lasers and amplifiers to higher output powers while maintaining substantially single-transverse-mode operation. For example, some of the present techniques can be applied to or implemented in different types of fiber-based laser and amplifier systems, including, without limitation, systems used in material processing fields such as memory repair, photovoltaic cell processing or micro-milling, and in applications that can benefit from laser beams having diffraction-limited spot sizes, longer depths of focus, and/or high beam quality (e.g., for laser-frequency conversion).

In the present description, the terms “light” and “optical”, and derivatives and variants thereof, are used to refer to radiation in any appropriate region of the electromagnetic spectrum and, more particularly, are not limited to visible light. For example, in implementations for use in high-power fiber-based laser and amplifier systems, the terms “light” and “optical” may encompass electromagnetic radiation having a wavelength ranging from about 900 nm to about 2 μm. However, some types of optical fibers have demonstrated waveguiding properties at optical wavelengths ranging from about 200 nm (deep ultraviolet) to about 8 μm (mid-infrared). These wavelengths are also encompassed in the scope of the present techniques.

The propagation of light in an optical fiber is often described in terms of LP (linear polarization) modes. The lowest-order mode is the fundamental transverse mode LP₀₁, which has two polarization states and an irradiance profile that resembles that of a Gaussian beam. The first higher-order transverse mode is the LP₁₁ mode. The LP₁₁ mode is two-fold degenerate in orientation, with an even mode exhibiting a cosine angular dependence and an odd mode exhibiting a sine angular dependence. Each of these two orientations has two possible polarization states. For illustrative purposes, reference will be made herein primarily to the LP₁₁ mode group. However, it should be noted that the higher-order-mode filtering techniques disclosed herein are generally applicable to other higher-order modes and mode groups.

In the present description, the term “winding”, as well as derivatives and variants thereof, can be used interchangeably with other terms such as, for example, “wrapping”, “coiling”, “spooling”, “bending”, and derivatives and variants thereof.

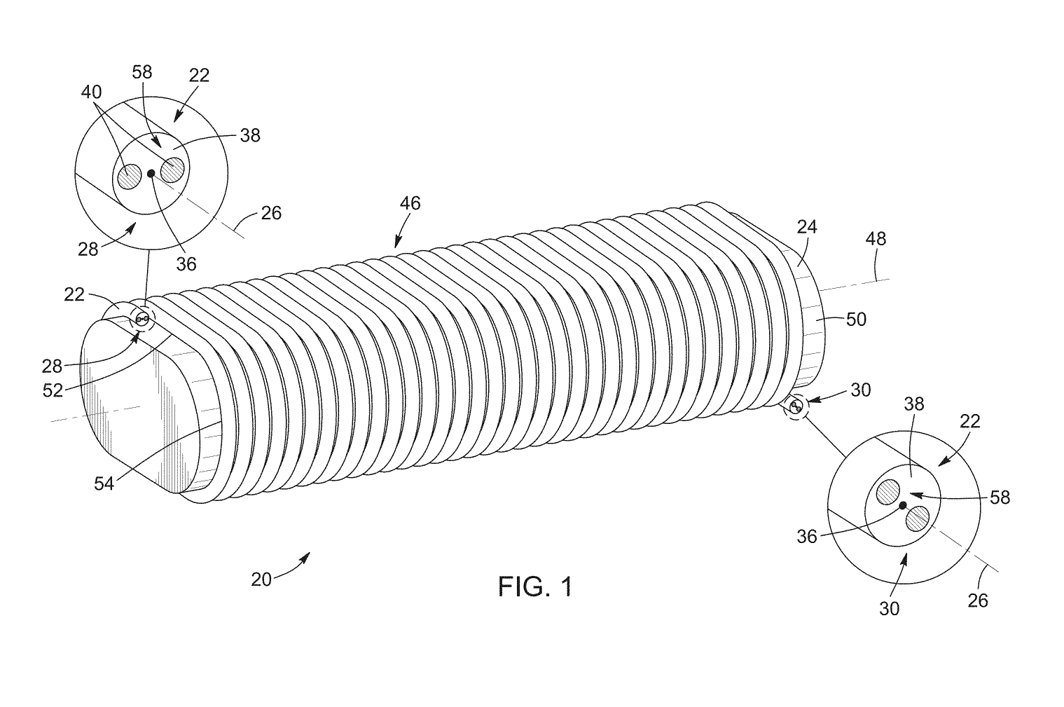

Referring to FIG. 1, a first exemplary embodiment of an optical fiber assembly 20 for filtering out higher-order modes is shown. For brevity, the expression “optical fiber assembly” may, in some instances, be shortened to “fiber assembly”. In the illustrated embodiment, the optical fiber assembly 20 includes two main components: an optical fiber 22 and a winding support 24 onto which the optical fiber 22 is wound. In some implementations, the winding support 24 and the optical fiber 22 may be provided or sold together as a kit. In such cases, the optical fiber assembly 20 can be assembled by winding the optical fiber 22 onto the winding support 24. More regarding the structure, configuration and operation of these and other possible components of the optical fiber assembly 20 will be described in greater detail below.

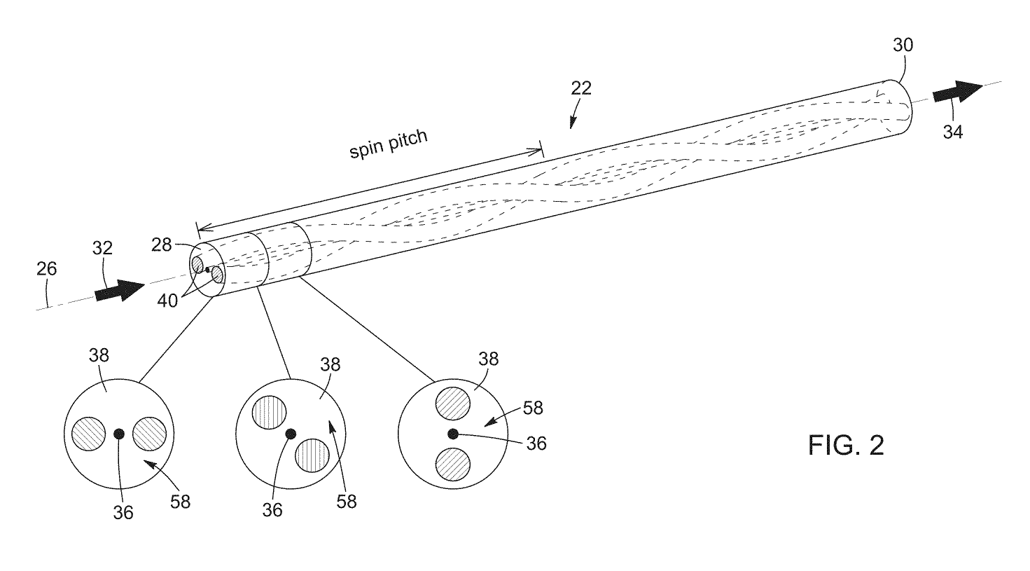

Referring to FIG. 1, and further to FIG. 2, the optical fiber 22 has a longitudinal fiber axis 26 and extends between an input end 28 and an output end 30. For brevity, the term “longitudinal fiber axis” may, in some instances, be shortened to “longitudinal axis” or “fiber axis”. In FIG. 2, the optical fiber 22 is shown in a straight, unwound configuration to better illustrate some of its features described below. The optical fiber 22 receives an input optical beam 32 at the input end 28 (e.g., from a continuous-wave or a pulsed laser source) and radiates an output optical beam 34 from the output end 30. In the illustrated embodiment, the optical fiber 22 is a polarization-maintaining (PM) fiber, although non-PM fibers can also be used in other embodiments, as discussed further below.

Depending on the application or use, the optical fiber 22 can be a passive fiber or an active fiber including a gain medium (e.g., a rare-earth-doped core) for providing optical amplification. In some implementations, the optical fiber 22 can be a large-mode-area (LMA) fiber, which can be well suited for use in high-power fiber lasers and amplifiers. The optical fiber 22 can have various refractive index profiles such as, for example, a graded-index profile or a step-index profile (e.g., a depressed cladding step-index profile). The optical fiber 22 may support different polarization states of the light propagating therein. In some implementations, the optical fiber 22 may be a multicore optical fiber.

In the exemplary embodiment of FIGS. 1 and 2, the optical fiber 22 is a PM fiber. The optical fiber 22 includes a light-guiding core 36, a cladding 38 surrounding the core 36, and a transverse cross-section 58 having at least one characteristic lacking circular symmetry. In the present description, the term “circular symmetry”, also called “cylindrical symmetry”, refers to a rotational symmetry with respect to any arbitrary azimuthal angle around the fiber axis, such that the rotation of the transverse cross-section of the fiber by any azimuthal angle around the fiber axis maps onto itself. Depending on the implementations, the at least one characteristic causing the absence of circular symmetry in the transverse cross-section of the fiber can be provided by structural asymmetry (e.g., a non-circular core and/or cladding) and/or by positional asymmetry (e.g., an off-centered core, the presence of stress-applying parts (SAPs) disposed around the core). In the illustrated embodiment, the lack of circular symmetry of the transverse cross-section 58 of the fiber 22 arises from a pair of SAPs 40 disposed in the cladding 38 and positioned on diametrically opposed sides of the core 36. In PM fibers, asymmetry is deliberately introduced (e.g., by stress and/or geometry) to produce birefringence and preserve the polarization of guided light over long propagation distances. However, in other embodiments, other types of standard or specialty optical fibers may be used.

The core 36 has a refractive index higher than the index of the cladding 38 so that light can be guided therealong. Depending on the application or use, different core and cladding material compositions can be used. By way of example, the core 36 can be made of silica containing one or more index-changing dopants (e.g., rare-earth dopant materials such as erbium, ytterbium and thulium in the case of active fibers, and GeO₂, P₂O₅, Al₂O₃, and F in the case of passive fibers). The cladding 38 can be made of pure silica. In other embodiments, other suitable materials can be used for the cladding and the core (e.g., plastic, sapphire, and composite glasses).

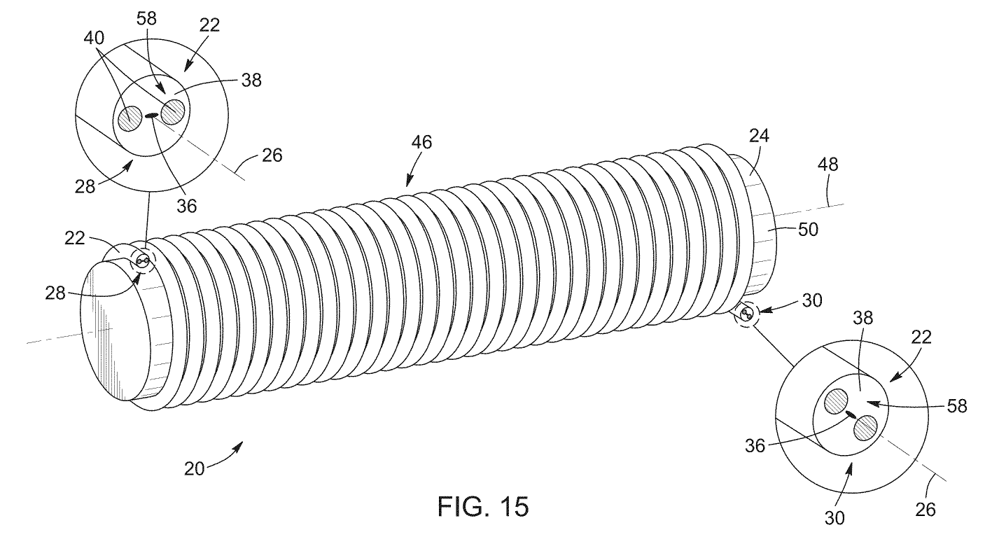

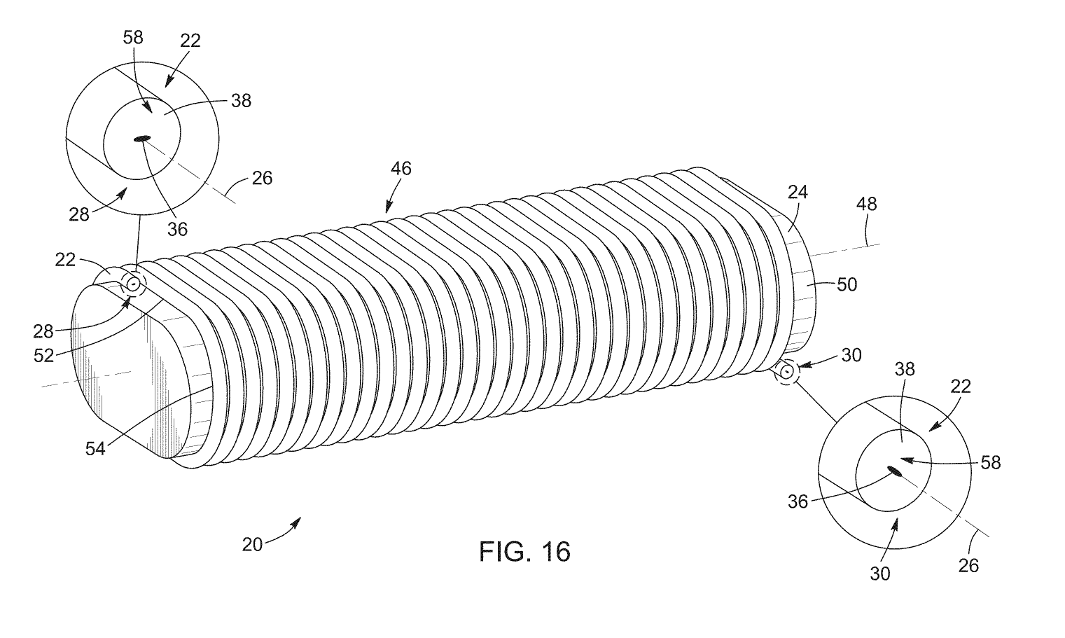

In the embodiment illustrated in FIGS. 1 and 2, the core 36 has a circular cross-section and is centered on the fiber axis 26. Other geometries are possible in alternative embodiments, for example a core with a non-circular transverse cross-section (e.g., elliptical; see FIGS. 15 and 16) and/or cores which are off-centered from the fiber axis 26. The core 36 has a sufficiently large cross-sectional area to support the propagation of a fundamental mode and one or more higher-order modes. By way of example, in one implementation, the core 36 is an LMA Yb-doped core operating at or near 1060-nm wavelength and having a diameter ranging from about 10 μm to about 50 μm or more, although many other operating wavelengths and core sizes can be used depending on the application, use and/or operating conditions. The cladding 38 surrounding the core 36 may also have a circular or non-circular geometry, and may consist of either a single cladding layer or multiple cladding layers (e.g., double-clad and triple-clad structures).

Referring still to FIGS. 1 and 2, the SAPs 40 include two stress rods inserted in the cladding 38 and extending parallel to the fiber axis 26 along diametrically opposed paths with respect to the core 36. Depending on the application or use, the SAPs 40 may or may not extend along the entire length of a segment of fiber 22. The SAPs 40 are typically made of a material (e.g., boron-doped silica) having a coefficient of thermal expansion that differs (e.g., typically larger) from that of the cladding material. When the SAPs 40 cool down after the fiber 22 has been drawn from the preform, they apply an anisotropic mechanical stress or strain to the core 36 due to their different coefficient of thermal expansion, resulting in a permanent, built-in internal birefringence.

In the illustrated embodiment, the SAPs 40 have a circular cross-section, which is known as a PANDA configuration. Of course, in other embodiments, the number, arrangement, size and cross-sectional shape of the SAPs 40, as well as their proximity (or contact) with the core 36 may be different. For example, some variants can include a single SAP, while other variants can include more than two SAPs. Furthermore, besides PM fibers with SAPs (e.g., PANDA, bow-tie, elliptical cladding and elliptical jacket), other types of PM fibers may be used in other embodiments, such as PM fibers with geometrical asymmetry and PM fibers with refractive index modulation. It is worth mentioning again that the techniques disclosed herein can be applied to both PM and non-PM fibers.

Referring still to FIGS. 1 and 2, the optical fiber 22 has a spin imparted thereto about the longitudinal fiber axis 26. Such specialty optical fibers can be referred to as “spun fibers”. In the present description, the terms “spin”, “spun” and other derivatives thereof are intended to refer to a rotational deformation which is impressed on the fiber while the fiber material is in a viscous and substantially unstressed state, and which is preserved as a permanent structural modification once the fiber has cooled down. In this context, the term “permanent” is intended to refer to a deformation which is essentially non-reversible under normal operating conditions and for the intended lifetime of the optical fiber. Depending on the application or use, the spin may be impressed on the fiber along the entire or a partial length thereof.

By way of example, the spun optical fiber 22 shown in FIG. 2 may be fabricated by spinning a PANDA-type PM preform about the fiber-drawing axis during drawing. Due to spinning, the two SAPs 40 will rotate in a helical fashion around the fiber axis 26 as one moves longitudinally along the fiber 22. Spun fibers may be advantageous with a fiber having a transverse cross-section that lacks circular symmetry. In the present techniques, non-limiting examples of optical fibers that could benefit from having a spin impressed thereon during drawing can include PM fibers including pairs of SAPs disposed on opposite sides of the core (e.g., as shown in FIGS. 1 and 2), fibers with a non-circular core (e.g., as shown in FIGS. 15 and 16), fibers with an off-centered core, fibers having a non-circular cladding layer, multicore fibers, and any other suitable fiber having at least one characteristic lacking symmetry with respect to the fiber.

Generally, an optical fiber may be spun according to a spin function or profile. As used herein, the term “spin function” is intended to refer to the rate (e.g., in units of degrees per unit length or turns per unit length) and direction (i.e., left-handed or right-handed) of the spin imparted to the fiber as a function of position along the fiber. The spin function may be of any kind, although a unidirectional spin function with a constant rate is often favored. A notable parameter of the spin function is the spatial repetition period, or spin pitch, which represents the length of fiber needed to complete a rotation of 360° about the fiber axis. Depending on the application, the spin pitch may be constant or vary locally, periodically or not, as a function of position along the fiber.

Spun fibers have been used in various application areas, including optical telecommunications and fiber sensing. Spun fibers can allow fiber imperfections such as deviations from circular symmetry and other non-uniformities to be spread out along all possible azimuthal directions. Undesired local fast and slow birefringence axes are thus averaged out, resulting in an optical fiber wherein the effect of stress and shape anisotropies can be significantly reduced. By way of example, in telecommunication applications, imperfections introduced during the fabrication process can produce a locally varying birefringence which, after a certain propagation distance, can give rise to detrimental effects such as polarization mode dispersion (PMD) and pulse spreading. In such cases, spinning the preform at a high spin rate (i.e., short spin pitch) during drawing can produce a substantially isotropic spun fiber in which such fabrication-induced imperfections are averaged out. Similarly, using spun fibers in electrical current sensors based on the Faraday effect can also help eliminate or mitigate unwanted linear birefringence. In these applications, the spin pitch is often selected to be small compared with the intrinsic polarization beat length of the corresponding “unspun” fiber to effectively average out fiber imperfections. The polarization beat length is defined as the wavelength divided by the linear birefringence and represents the fiber length over which a phase retardation of 360° is introduced between light polarized along the slow axis and light polarized along the fast axis.

In contrast, the benefit of using spun optical fibers in the present techniques generally lies more in the ability of spun optical fibers to rotate certain fiber parameters (e.g., the birefringence axes or the irradiance distribution of higher-order modes; see more in this regard below) than to smooth out non-circularly symmetrical fiber features (e.g., for reducing PMD). In some implementations, for example those using PM fibers, it may be advantageous that the spatial repetition period, or spin pitch, be long compared with the unspun polarization beat length. This is because, in such a case, the fiber parameters are rotated sufficiently slowly to ensure or help ensure that any intrinsic or induced (e.g., via SAPs) linear birefringence present in the corresponding unspun fiber will be substantially preserved in the spun fiber. When the spin is sufficiently slow, a spun PM fiber tends to behave as a linear PM fiber in which the two polarization eigenstates follow the rotation of the birefringence axes. By way of example, in some implementations, the spun optical fiber can have a spatial repetition period that ranges from a few centimeters to a few tens of centimeters (e.g., between about 1 cm and about 50 cm in a non-limiting embodiment), while the unspun polarization beat length may range typically from about 3 millimeters (mm) to about 1 cm.

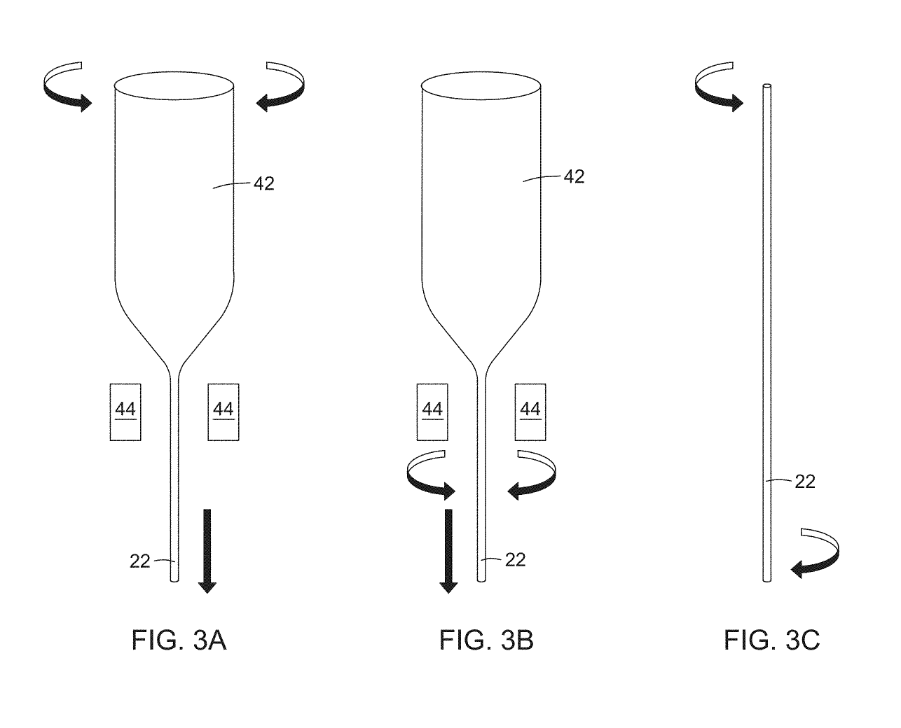

Turning to FIGS. 3A and 3B, there are shown schematic representations of two techniques to impart spin to an optical fiber 22 during drawing: the preform spinning technique (FIG. 3A) and the fiber spinning technique (FIG. 3B). In the preform spinning technique, the spin is imparted by rotating the preform 42 during drawing (while preventing rotation of the drawn fiber 22 itself), whereas in the fiber spinning technique, the spin is imparted by rotating the fiber 22 itself as it is drawn from the preform 42. It is noted that in the fiber spinning approach, the torsional torque should be applied to the fiber 22 near the furnace 44 of the fiber-drawing tower, where the fiber 22 is maintained in a soft, substantially molten state. Depending on the application or use, the spun fiber of the fiber assembly disclosed herein may have been fabricated using either the preform or the fiber spinning technique.

In other implementations, a spun optical fiber can be obtained by post-drawing processing. Such processing can involve the following steps: performing a conventional drawing process to obtain an “unspun” optical fiber, that is, an optical fiber produced without spin; locally heating the unspun optical fiber to bring at least a portion thereof to a soft and viscous state; applying a torque to the locally heated portion of the unspun fiber such that a spin is imparted to the locally heated portion and preserved as a frozen-in structural modification upon cooling. While the application of this technique is often restricted to a limited segment of fiber, it can provide increased flexibility in terms of engineering the imparted spin properties.

It should be noted that the terms “spin” and “twist” are employed in the art to describe two distinct types of rotation or torsion that can be impressed on or applied to an optical fiber. This distinction will be adopted in the present description. As defined above, the term “spin” refers to a rotation applied to the fiber, typically during drawing, in a way that produces a substantially permanent deformation after cooling. In contrast, the term “twist” refers to an elastic torsion imposed to a post-drawn fiber, such that the fiber will return to its original state after removing the torsional torque. Depending on the application or use, the optical fiber in the fiber assembly disclosed herein may have a spin and/or a twist imparted thereto. As used herein, an optical fiber having a “rotation” imparted or applied about its longitudinal axis is meant to encompass both an optical fiber having a permanent spin impressed thereon and an optical fiber having an elastic twist or torsion applied thereto during use. In some implementations, spun fibers can be favored compared to twisted fibers due to their mechanical simplicity and stability, resistance to long-term fatigue, and manufacturing flexibility.

Returning to FIG. 1, the winding support 24 is the component of the optical fiber assembly 20 about which the optical fiber 22 is wound into a coil to define a winding path 46 about a winding axis 48. In the present description, the term “winding support” is intended to refer to any component or combination of components that can provide a winding surface about or onto which an optical fiber can be wound. By way of example, the winding support 24 can include a mandrel, a spool, a bobbin, a reel, a plate, or another suitable device. In some implementations, the winding support 24 can have peripheral grooves, threads, channels or recesses (not shown) formed in or upon its winding surface 50 in view of receiving and guiding the wound fiber 22 or a portion thereof.

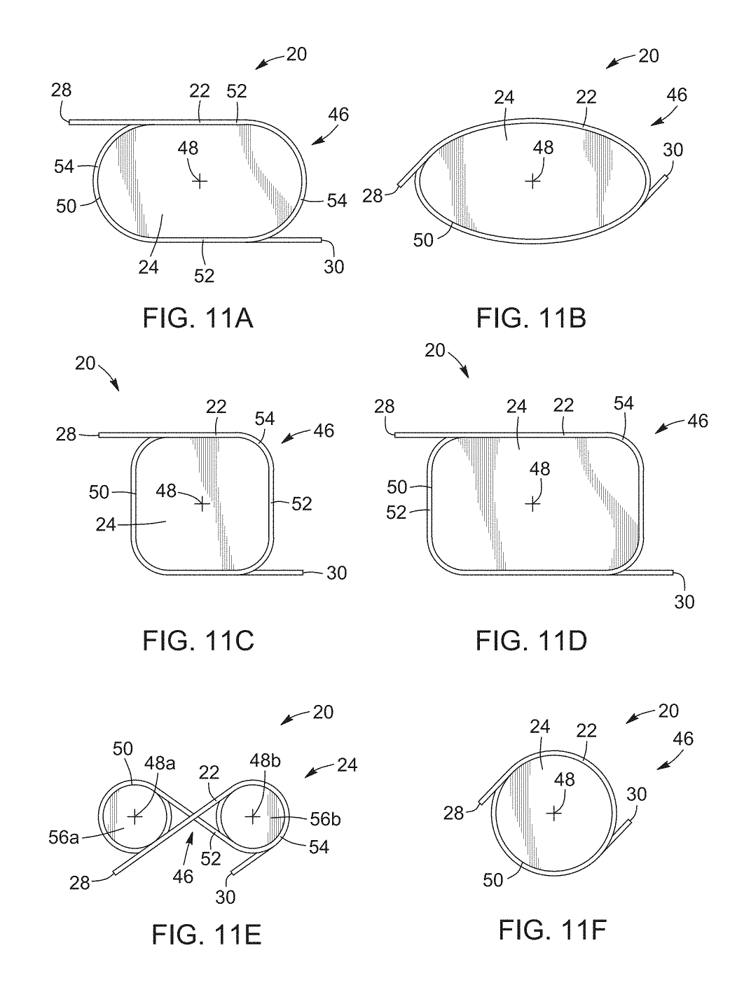

Depending on the application or use, the winding support 24 may be formed of either a single or a plurality of members, and may be configured to provide a single or a plurality of winding axes about which the fiber 22 can be wound along the winding path 46. By way of example, FIG. 11E illustrates a configuration where the winding support 24 includes two winding members 56a, 56b and two winding axes 48a, 48b in a “figure-of-eight” arrangement. In some implementations, the winding support 24 can be made of a material having a good thermal conductivity to favor dissipation of the heat generated as a result of absorption of a part of the light propagating along the wound optical fiber 22.

Returning to FIG. 1, in the illustrated embodiment, the winding surface 50 is defined by the cross-sectional shape or profile of the winding support 24 perpendicularly to the winding axis 48. In turn, the winding surface 50 essentially defines the winding path 46 followed by the coiled fiber 22. Typically, the winding path 46 consists of a plurality of turns, or revolutions, of the fiber 22 about the winding axis 48. Each turn of the winding path 46 represents a length of fiber defined by a rotation of 360° around the winding axis 48. Each turn can also be said to define a figure, or a trajectory. This figure, or trajectory, may be characterized by its shape, or contour, and by its size, or area.

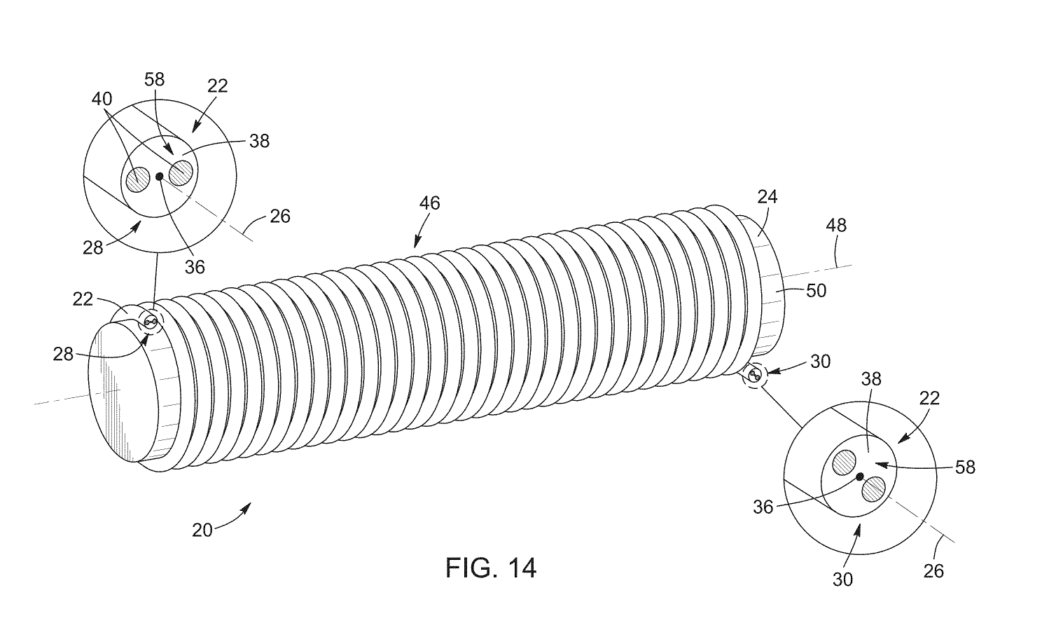

In some implementations, the winding path 46 can be non-circular, that is, it can have a non-constant radius of curvature. More particularly, in FIG. 1 each turn of the winding path 46 includes four segments, namely two straight segments 52 parallel to each other and joined at their ends by 180° semicircular segments 54 (see also FIG. 11A). Of course, the number of turns can vary depending on the application or use. By way of example, in some non-limiting embodiments, the number of turns can range from about a few turns to a few tens of turns. Also, depending on the winding configuration used, successive turns of the winding path 46 may be in physical contact or spaced apart from each other. However, in other implementations, the winding path 46 can be circular, that is, it can have a constant radius of curvature, as illustrated in FIG. 14 (see also FIG. 11F).

In the embodiment of FIG. 1, the winding path 46 followed by the optical fiber 22 has a helicoidal configuration. In the present description, the terms “helix”, “helicoidal”, “helical” and derivatives thereof refer to a three-dimensional figure, trajectory or curve that involves simultaneously both a rotation around and a translation along the winding axis. It is noted that the terms “helix”, “helicoidal”, “helical” and derivatives thereof should not be construed by their narrowest geometrical definition and are meant to encompass both true helices (i.e., circular helices with a constant radius of curvature) and helix-like structures having a non-constant radius of curvature. Depending on the application or use, each of the pitch and the angle of the helix may be constant or vary along the helix axis.

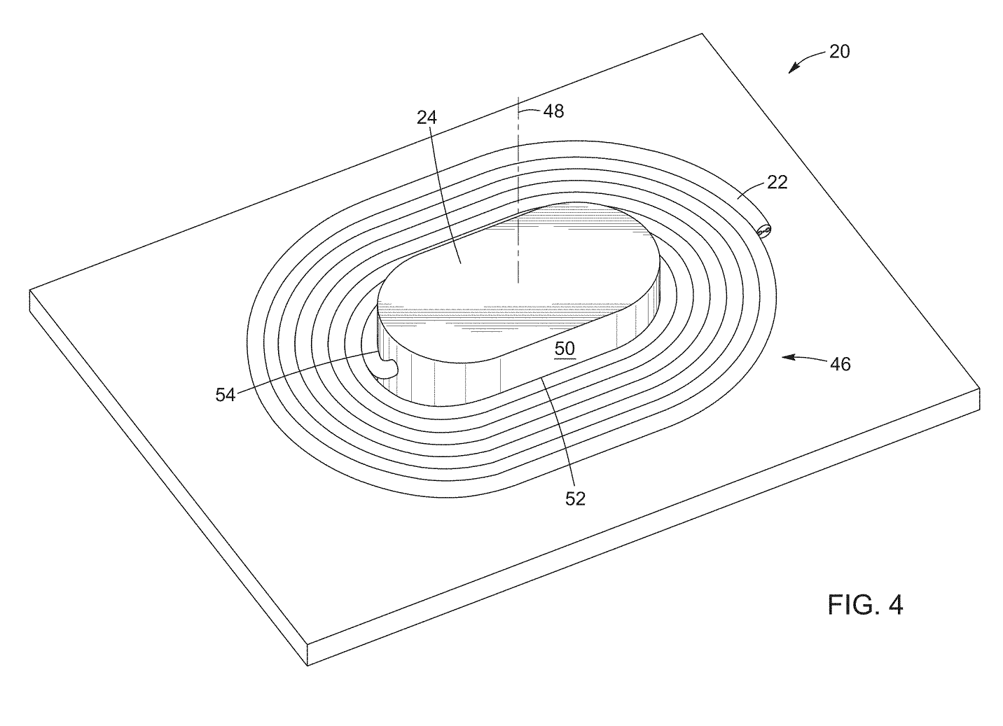

Referring to FIG. 4, in an alternative embodiment the winding path 46 may define a two-dimensional curve having a spiral configuration. As used herein, the term “spiral” and derivatives thereof refer to a winding path lying substantially in a single plane and including a plurality of turns of increasing size as one moves outwardly away from the winding axis. It is noted that the term “spiral” is meant to encompass both circular spirals and non-circular spiral-like structures. It is also noted that both circular and non-circular spiral structures are characterized by a non-constant radius of curvature along the winding path. More detail regarding the configuration (e.g., the size and shape) of the winding path and its role in providing enhanced filtering of higher-order modes in the techniques disclosed herein will be given further below.

Returning to FIG. 1, it is noted that bending of an optical fiber is a well-known and widely used technique to filter out higher-order-mode power from an optical signal propagating in a multimode optical fiber. Fiber bending takes advantage of the fact that higher-order modes are bound less tightly to the fiber core than the fundamental mode, making higher-order modes more sensitive to bending losses. Therefore, as light propagates along a bent fiber, higher-order modes can be converted into radiation modes and then more easily filtered out of the core than the fundamental mode. By proper adjustment of the bending radius, higher-order modes can be suppressed or at least reduced while the fundamental mode can remain substantially unaltered, experiencing no increased losses or coupling with other modes.

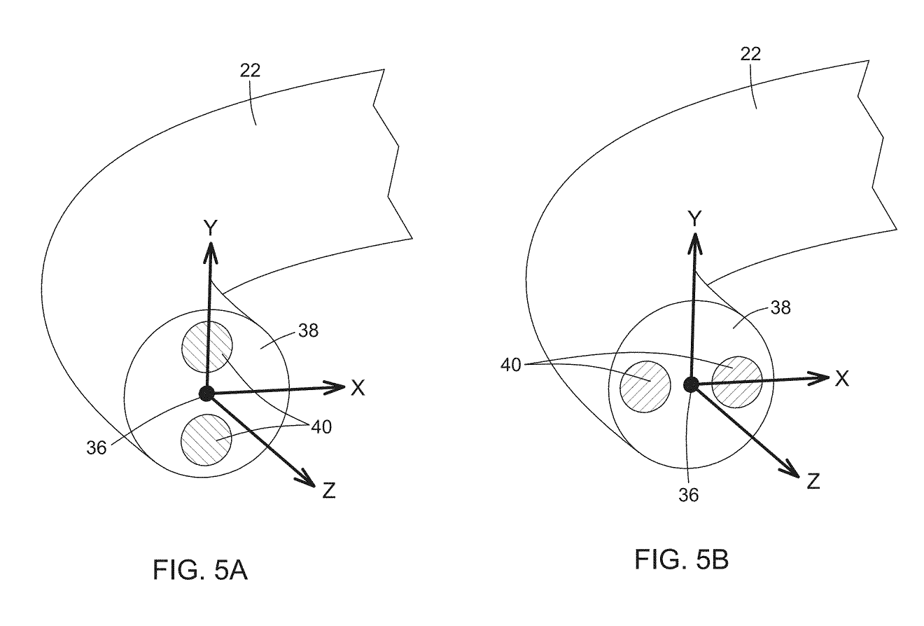

A drawback or limitation of higher-order-mode filtering by fiber bending is that this technique is difficult or at least not straightforward to scale up to large core diameters, that is, core diameters larger than a few tens of micrometers. This is because as the core diameter increases, the propagation constants of the fundamental mode and of the neighboring higher-order modes become closer, thus making modal discrimination increasingly difficult with increasing core area. Another challenge of mode filtering by fiber bending arises in the case of PM fibers with SAPs disposed about the core. This is because the filtering efficiency generally varies with the orientation of the SAPs with respect to the plane of bending (e.g., the angle between the imaginary line joining the centers of the SAPs and the plane of bending in the case of the PANDA configuration). In general, the attenuation of higher-order modes is significantly higher when the line joining the SAPs is perpendicular to the plane of bending. More regarding the anisotropic dependence of higher-order-mode filtering on the orientation of SAPs in conventional unspun PM fibers will now be described, while referring to FIGS. 5A to 9B.

Referring to FIGS. 5A and 5B, there are shown two different orientations of a conventional unspun PM fiber 22 having a step-index profile and including two SAPs 40 arranged in a PANDA configuration. In both orientations, the fiber 22 is wound into a circular coil lying in a bending plane parallel to the XZ plane. The core 36 of the fiber 22 has a diameter of 18 μm and a numerical aperture (NA) of 0.07. In FIG. 5A, the imaginary line joining the SAPs 40 is parallel to the Y axis and perpendicular to the bending plane XZ (i.e., parallel to the winding axis). In FIG. 5B, the imaginary line joining the SAPs 40 is parallel to the bending plane XZ (i.e., perpendicular to the winding axis).

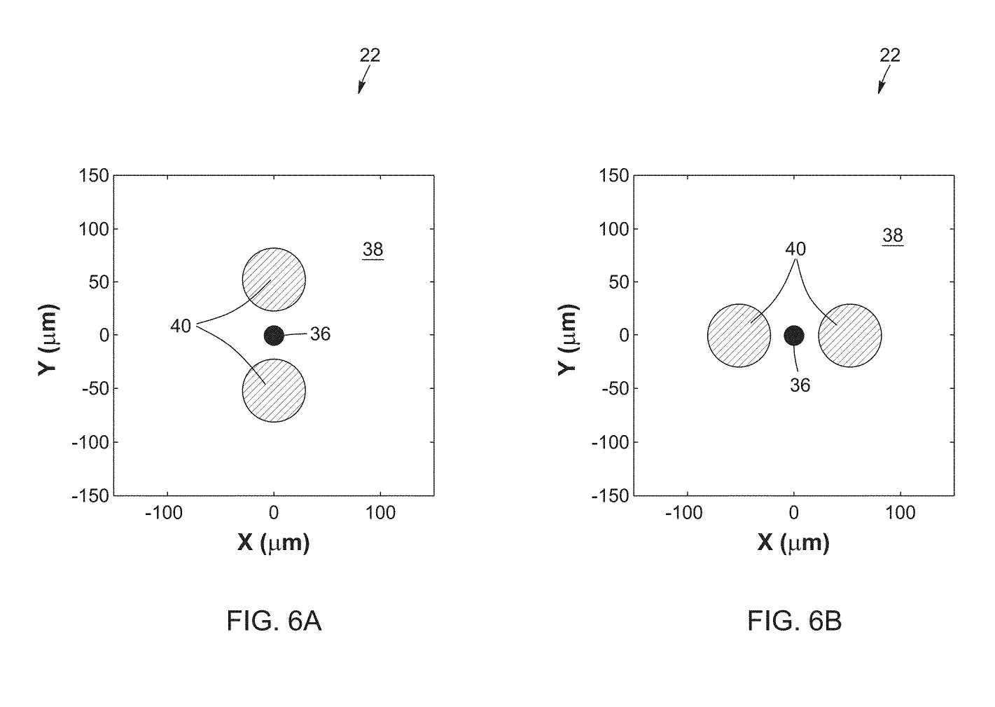

FIGS. 6A and 6B show schematic cross-sectional views of the fiber 22 of FIGS. 5A and 5B, respectively, where the fiber dimensions along the X and Y axes are indicated.

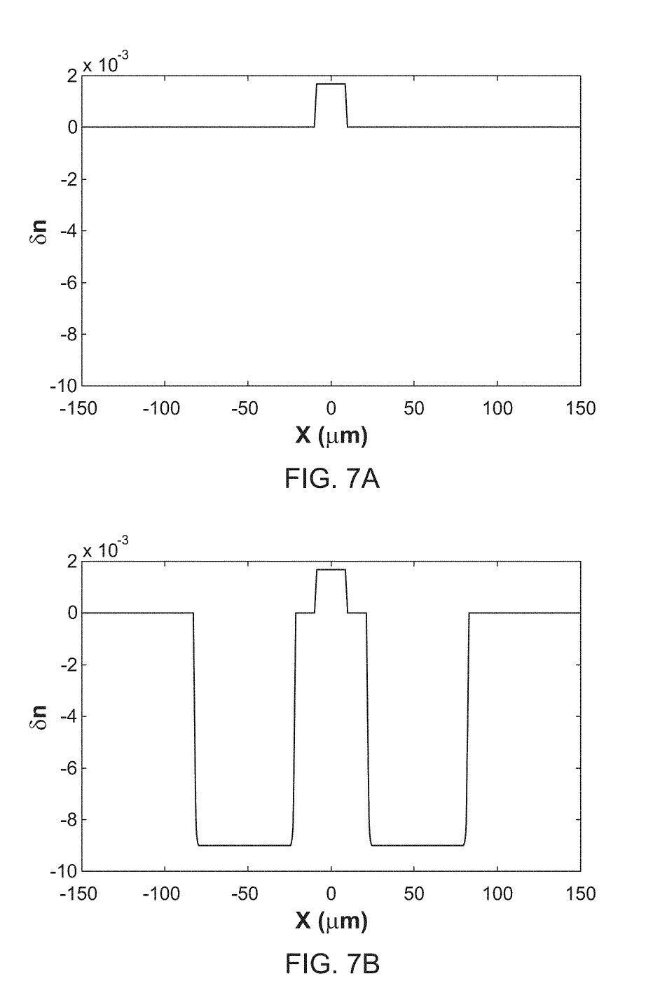

FIGS. 7A and 7B show the refractive index profile of the fiber with respect to that of the cladding along the X axis for the fiber orientations of FIGS. 5A and 5B, respectively.

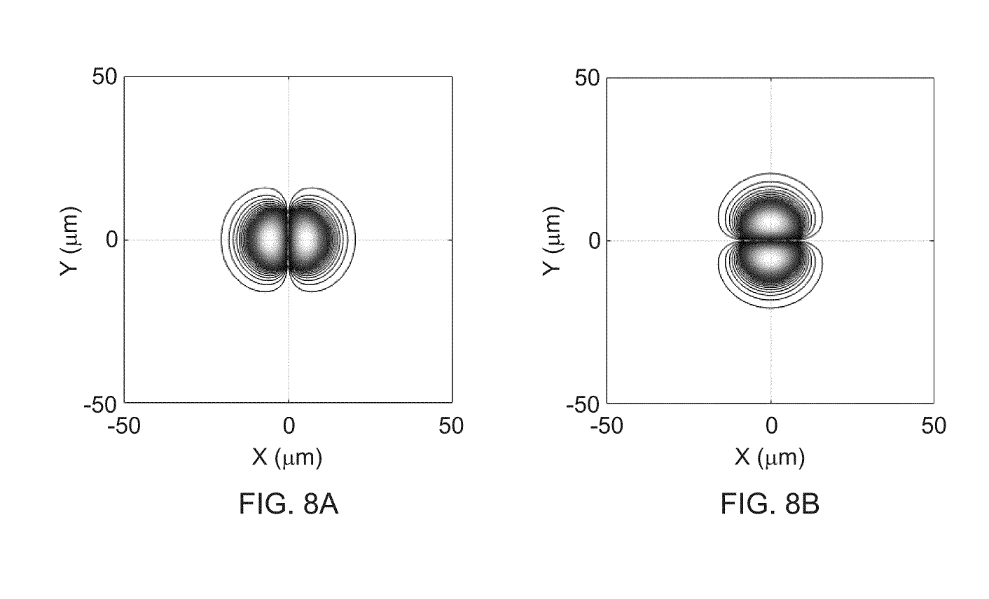

Referring now to FIGS. 8A and 8B, there are shown the irradiance distributions of the even (FIG. 8A) and the odd (FIG. 8B) LP₁₁ modes of a conventional unspun PM fiber corresponding to that of FIGS. 5A and 5B, except that the fiber in FIGS. 8A and 8B is in a straight (i.e., unbent and uncoiled) state. The operating wavelength is 1060 nm. Comparing FIGS. 8A and 8B, it is seen that the even and odd LP₁₁ modes are mutually orthogonal and that their energy is distributed predominantly along the X axis for the even mode (FIG. 8A) and predominantly along the Y axis for the odd mode (FIG. 8B). Therefore, when the fiber is bent or wound in a plane parallel to the XZ plane, as in FIGS. 5A and 5B, the even LP₁₁ mode tends to be converted into radiation modes and filtered out more easily than the odd LP₁₁ mode.

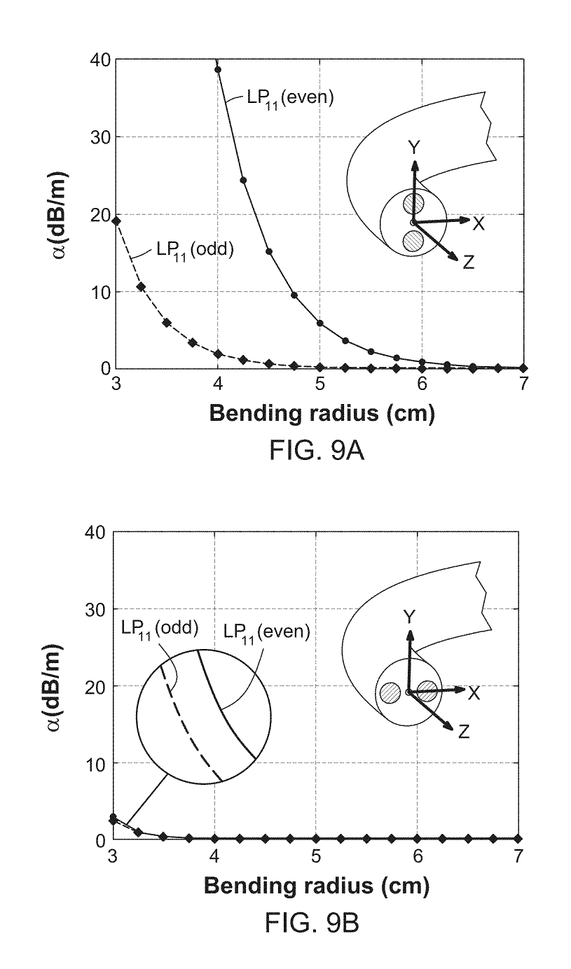

Turning to FIGS. 9A and 9B, bending loss curves plotted as a function of the bending radius are shown for the fiber bending orientations of FIGS. 5A and 5B, respectively. In each plot, the solid curve corresponds to the even LP₁₁ mode and the dashed curve corresponds to the odd LP₁₁ mode. The operating wavelength is still 1060 nm. Comparing FIGS. 9A and 9B, it can be observed that the attenuation of both the even LP₁₁ mode and the odd LP₁₁ mode is significantly more effective in FIG. 9A, where the SAPs are aligned perpendicularly to the bending plane (as in FIG. 5A) than in FIG. 9B, where the SAPs lie in the bending plane (as in FIG. 5B). In other words, the orientation of the SAPs relative to the bending plane has an impact on the filtering efficiency of the higher-order modes. The origin of this orientation anisotropy can be explained on the basis that when the imaginary line joining the SAPs is parallel to the bending plane, extracting the higher-order modes out of the core tends to become exceedingly difficult due to the significant refractive index depression produced by the SAPs, which acts as an optical barrier that hinders mode filtering. This can be seen by comparing the refractive index profiles of FIG. 7A (no optical barrier) and 7B (optical barrier present). Moreover, although in FIG. 9A the bending losses of the odd LP₁₁ mode (dashed curve) are lower than those of the even LP₁₁ mode (solid curve), the bending losses of the odd LP₁₁ mode remain sufficiently large to provide adequate mode filtering in most applications. However, in FIG. 9B, the bending losses of the even and odd LP₁₁ modes are both significantly reduced compared with those in FIG. 9A, due to the detrimental effect of the SAPs on the attenuation of higher-order modes when oriented as in FIG. 5B.

It will be recognized that the longer the fiber, the higher the probability that the orientation of the SAPs will vary along the fiber between the two limiting cases of FIGS. 5A and 5B, and, in turn, the higher the probability that the effective bending losses will fall somewhere between those plotted in FIGS. 9A and 9B. Such variations in the azimuthal orientation of the SAPs along the fiber length are generally more or less random and are typically introduced naturally during the fabrication of conventional PM fibers. For relatively long fibers (e.g., a few tens of meters in length or longer), these natural variations in the orientation of the SAPs around the core may, in some applications, provide adequate higher-order-mode filtering. In recent years, however, a trend in the design of LMA active fibers has been to improve optical pump absorption to allow the use of shorter fibers and, consequently, to mitigate nonlinear effects. In turn, reducing the length of stress-based PM fibers generally increases the likelihood that the SAPs will be oriented unfavorably for mode filtering over a significant portion of the coiled fiber.

To address or at least alleviate these issues, there is provided optical fiber assemblies and methods configured to implement a technique of mode filtering by differential bending losses using a coiled optical fiber having a rotation imparted about its longitudinal axis. The optical fiber can be a spun or twisted fiber. As mentioned above, a spun fiber is a specialty fiber having a spin having been permanently impressed thereon during or after drawing. As discussed above regarding FIG. 2, the impression of a spin in a PM fiber 22 having a pair of SAPs 40 causes the SAPs 40 to rotate along diametrically opposed helical paths about the core 36 along the fiber axis 26. It has been found that this variation in the azimuthal orientation of the SAPs 40, which can be periodic or not depending on the parameters of the spin imparted to the fiber 22, can average out local variations in bending losses occurring along the length of the coiled fiber 22, which, in turn, can enhance or favor the filtering efficiency of higher-order modes while allowing propagation of the fundamental mode.

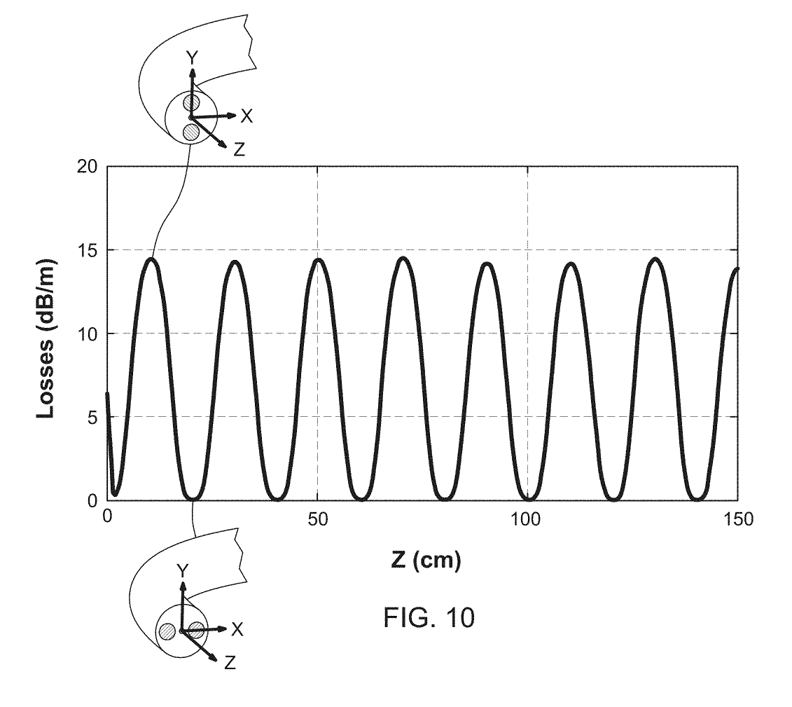

Referring now to FIG. 10, there are shown numerical calculations of bending loss curve plotted as a function of propagation distance in an optical fiber assembly including a spun PANDA-type PM fiber having a core diameter of 18 μm and being wound into a coil around a cylindrical mandrel having a radius of 4.5 cm. FIG. 14 shows an exemplary embodiment of such an optical fiber assembly 20, which includes an optical fiber 22 wound along a circular winding path 46 around a winding support 24. In FIG. 10, the operating wavelength is 1060 nm. At the fiber input located at position Z=0, light is launched into the fiber in the even LP₁₁ mode. As mentioned above regarding FIG. 9A, the optical irradiance distribution of the even LP₁₁ mode lies predominantly in the bending plane XZ. As light propagates in the fiber, the SAPs spin around the fiber axis at a 40-cm period, resulting in a quasi-periodic variation of bending losses as a function of Z, as illustrated in FIG. 10. Symmetry considerations explain why bending losses vary with a period equal to half the spin period of the SAPs. Bending losses vanish when the line joining the SAPs is aligned along the X axis (i.e., when SAPs lie in the bending plane) and increase to a maximum of about 14 dB/m after the SAPs have rotated by 90° to become aligned along the Y axis (i.e., when the SAPs are parallel to the bending axis), in agreement with what would be expected from the solid curve in FIG. 9A.

It should be noted that the choice for the spatial repetition period, or spin pitch, of 40 cm in the calculations presented in FIG. 10 is for illustrative purpose only. By way of example only, a spatial repetition period of about 1 cm, or about 2 cm, or about 5 cm, or about 10 cm, or about 20 cm, or about 30 cm, or about 40 cm, or about 50 cm can generally be achieved with conventional fabrication processes, and may be used in some non-limiting implementations of the fiber assembly disclosed herein. A shorter or a longer spatial repetition period may also be used in other embodiments.

It should also be noted that, in general, the use of a spun optical fiber having a constant spin pitch is not essential to provide enhanced filtering of higher-order modes, though it may be beneficial in some cases. Indeed, depending on the application or use, the spin pitch may be constant or may vary, periodically or not, along the fiber length. By way of example, in some implementations the spatial frequency spectrum of the spin pitch may range from about 5°/cm to about 180°/cm or even 360°/cm. Furthermore, the spin impressed on the fiber may have a constant handedness (i.e., a unidirectional spin function that is either everywhere left-handed or everywhere right-handed) along the fiber or may alternate, periodically or not, between a left-handed and a right-handed helicity.

For larger cores, the difference in bending losses between the even and odd LP₁₁ modes (see FIG. 9A) may become problematic, even when a spun optical fiber is used to provide a helical arrangement of the SAPs around the fiber core. Such an issue can arise because, as the core size increases, the effective filtering of the odd LP₁₁ mode, whose irradiance lies mostly parallel to the winding axis (see FIG. 8B), can require such a small bending radius that the fundamental mode LP₀₁ itself is attenuated.

It should be emphasized that, in contrast to the rotation imparted to the SAPs in a PM fiber, a spun fiber will generally not induce a corresponding rotation of the even and odd LP₁₁ modes when the spun fiber is wound or bent. This is because the orientation of the symmetry axes of the LP₁₁ modes is governed primarily by the orientation of the bending or winding plane, even when a spin has been impressed on the coiled fiber. In other words, fiber bending tends to impede the rotation of the LP₁₁ modes, even in a spun fiber. Furthermore, fiber bending generally introduces an asymmetry in the refractive index profile by adding a constant gradient to the refractive-index profile along the axis lying in the bending plane (i.e., the X axis in FIGS. 5A and 5B). The even and odd LP₁₁ modes therefore see different refractive indices, which translate to different bending losses. Consequently, the filtering efficiency of the LP₁₁ mode, (and of higher-order modes in general) will tend to depend strongly on the relative orientation between the bending plane and the spatial irradiance profile of the mode (i.e., even or odd), especially for LMA fibers.

It should be noted that the difficulty in filtering one of the two LP₁₁ modes with increasing core size arises not only in PM fibers, but also in non-PM fibers. It should also be noted that in the exemplary embodiments described so far, the X axis lies in the bending plane and, thus, it is the odd LP₁₁ mode that tends to be more difficult to suppress. However, in other exemplary embodiments, it could be the Y axis that lies in the bending plane, in which case it would be the even LP₁₁ mode which would tend to be more difficult to suppress. In other words, whether it is the odd or the even LP₁₁ mode that is more difficult to filter out depends on the choice of the coordinate system and its orientation with respect to the winding axis.

Numerical simulations have revealed that for large core sizes (e.g., core diameters larger than about 30 μm), the correspondingly small bending radii required to achieve adequate mode filtering of both even and odd higher-order modes give rise to a bending-induced asymmetry which tends to be large compared with the azimuthal asymmetry caused by the SAPs. As mentioned above, this bending-induced anisotropy can prevent or at least significantly hinder the rotation of the LP₁₁ mode group along the wound fiber, even for a spun optical fiber. This means that it may become difficult or even impossible to rotate the odd LP₁₁ mode by 90° to increase its bending losses to the level of those of the even LP₁₁ mode (or vice versa).

Referring now to FIG. 15, to overcome or at least alleviate this issue, some embodiments of the optical fiber assembly 20 include an optical fiber 22 with a core 36 having a slightly non-circular transverse cross-section, for example an elliptical transverse cross-section in the illustrated embodiment. It is noted that the ellipticity of the core 36 has been exaggerated in FIG. 15 for illustrative purposes. Numerical simulations have shown that, in some implementations, even a core with a non-circularity or ellipticity ratio (i.e., the ratio of the minor cross-sectional axis of the core to the major cross-sectional axis of the core) of more than about 0.95, or more than about 0.97, or more than about 0.99 can be sufficient to induce a gradual rotation of the even and the odd LP₁₁ modes along the coiled fiber, resulting in enhanced filtering of the odd LP₁₁ mode. It is noted that depending on the application, such a small non-circularity in the transverse cross-section of the core may be naturally present and/or be deliberately introduced during the manufacturing process.

However, in some applications, and particularly for LMA fibers, using a spun optical fiber with a non-circular (e.g., elliptical) core may still not be sufficient to induce bending losses that are high enough for both the even and the odd LP₁₁ modes. In such cases, it has been found that a coiled fiber assembly that combines both a spun optical fiber and a non-circular winding path, rather than a circular winding path, can allow the rotation and the efficient filtering of both LP₁₁ modes.

As used herein, the term “non-circular winding path” means a winding path having a non-constant radius of curvature, that is, a winding path along which the radius of curvature varies along at least a portion thereof. The points along a non-circular winding path are therefore not all equidistant from the winding axis. Non-limiting exemplary shapes for the non-circular winding path can include ellipses, ovals, polygons, polygons with rounded corners, spirals with outwardly increasing radius, curved segments having different radii, curved segments having the same radii but different centers, combinations of straight and curved segments, figures or eight or other more complex figures, and the like.

Returning to FIG. 1, and with further reference to FIG. 11A, the optical fiber 22 is wound around the winding support 24 along a non-circular winding path 46. In this exemplary embodiment, the non-circular winding path 46 is such that each turn consists of four segments including two straight segments 52 parallel to each other and joined at their ends by semicircular segments 54. Such a geometrical shape, consisting of two semicircles connected by parallel lines tangent to their endpoints, can be referred to as an “obround” shape or a “stadium” shape. It is noted that the embodiment of the fiber assembly 20 shown in FIG. 4 also has a winding surface 50 that defines an obround winding path 46 for the optical fiber 22. Therefore, depending of the application or use, the non-circular winding path 46 may have a helix-like, three-dimensional structure as in FIG. 1 (see also FIGS. 11A to 11F and FIGS. 14 to 16), or a spiral-like, two-dimensional structure as in FIG. 4.

The benefit of winding a spun optical fiber in a non-circular winding configuration that includes one or more straight or substantially straight segments is that the bending-induced asymmetry that prevents or impedes a spin-induced rotation of the even and the odd LP₁₁ modes along curved segments is absent or reduced along straight segments. In other words, the presence of straight or nearly straight segments along the winding path can allow the spin imparted to the fiber to induce an azimuthal rotation of fiber parameters (e.g., the orientation of the even and the odd LP₁₁ modes) that otherwise would not, or be more difficult to, rotate due to bending-induced anisotropy. Furthermore, as mentioned above, the benefit of using spun fibers in the present techniques generally lies more in their ability to cause a rotation of certain fiber parameters (e.g., the orientation of the SAPs or the orientation of the even and the odd LP₁₁ modes) than to smooth out the effects of features of the fiber that lack circular symmetry.

Referring still to FIG. 1 and FIG. 11A, in some implementations, it has been found that a predetermined rotation of the two LP₁₁ modes can be achieved by proper selection of the ratio between the spin pitch and the length of the straight segments 52. More particularly, in such implementations, it may be advantageous that the even and the odd LP₁₁ modes experience an odd integer number of 90° rotations during their propagation along each straight segment 52. This condition can be expressed mathematically by the following relationship: L_{straight}=[(2n−1)/4)]×Pₛₚᵢₙ, where L_{straight} is the length of a straight segment, Pₛₚᵢₙ is the spatial repetition period of the spin impressed on the fiber, and n is a positive integer higher than zero. In such scenarios, each straight segment 52 is configured to convert an even LP₁₁ mode into an odd LP₁₁ mode, and to convert an odd LP₁₁ mode into an even LP₁₁ mode. Each LP₁₁ mode will therefore alternate between an even and an odd symmetry after each passage through a straight segment 52. This also means that each LP₁₁ mode will have an even symmetry in half of the curved segments 54 and an odd symmetry in the other half of the curved segments 54. In turn, this will ensure that each LP₁₁ mode is in a favorable orientation for mode filtering in half of the curved segments 54. Consequently, an optical fiber assembly 20 providing enhancing filtering of both LP₁₁ modes can be obtained.

Regarding the embodiment illustrated in FIG. 1, numerical simulations have shown that, in general, the condition that the straight segments 52 impart an odd integer number of 90° rotations on the LP₁₁ modes need not be fulfilled exactly to achieve satisfactory filtering of both LP₁₁ modes. By way of example, it has been found that, in some implementations, other conditions may be established between the length of the straight segments 52 and the spatial repetition period of the rotation imparted to the fiber 22 (e.g., L_{straight}=[(2n−1)/3]×Pₛₚᵢₙ or L_{straight}=[(2n−1)/5]×Pₛₚᵢₙ), while still providing acceptable filtering efficiency.

Referring now to FIGS. 11B to 11E, non-limiting alternative configurations for the winding surface 50 of the winding support 24 are illustrated. In each case, the winding surface 50 defines a non-circular shape that differs from the obround shape shown in FIGS. 1, 4 and 11A, but that can alternatively be used in other variants to provide enhanced filtering of the higher-order modes. These other exemplary non-circular shapes can include an ellipse (FIG. 11B), a square with rounded corners (FIG. 11C), a rectangle with rounded corners (FIG. 11D), and a figure-of-eight configuration (FIG. 11E). In the case of the arrangements of FIGS. 11C and 11D, each turn of the winding path includes four straight segments 52 and four curved segments 54. In the case of a figure-of-eight configuration (FIG. 11E), the winding support 24 includes two cylindrical winding members 56a, 56b along which the fiber 22 is wound. In contrast to the embodiments shown in FIGS. 1, 4 and 11A to 11D, where the winding support 24 includes a single winding axis 48, the winding support 24 in the embodiment of FIG. 11E includes two winding axes 48a, 48b. For comparison purposes, FIG. 11F illustrates a case where the winding path 46 is circular.

In some embodiments, the winding support may allow adjustment of the shape and/or the size of the winding surface. Depending on the application or use, such an adjustment could be made before or while the spun fiber is wound onto the winding support. By way of example, in the non-limiting case of an obround winding surface, it could therefore be envisioned to mechanically adjust, possibly in real-time, the length of the straight segments and/or the radius of curvature of the curved segments to allow tuning of the higher-order-mode filtering properties of the fiber assembly.

Referring to FIG. 11B, it is noted that while an elliptical winding path 46 has no actual straight segments, it may still include portions where the bending radius is sufficiently large to produce a rotation of the LP₁₁ modes that is sufficient to allow their attenuation during propagation in the portions of the elliptical winding path 46 where the bending radius is smaller. In such scenarios, it may also be envisioned to use a slightly elliptical fiber core 36 (e.g., with an ellipticity ratio of more than 0.95 but less than 1, for example about 0.97) to further promote the rotation of the LP₁₁ modes along the coiled fiber 22. It is worth reiterating that while in some implementations a non-circular winding arrangement of the spun fiber may be beneficial to achieve an acceptable filtering performance, and in some instances preferable or even necessary, in other implementations, a circular winding arrangement of the spun fiber, combined or not with a core having a non-circular transverse cross-section (see, e.g., FIGS. 15 and 14, respectively) may be sufficient.

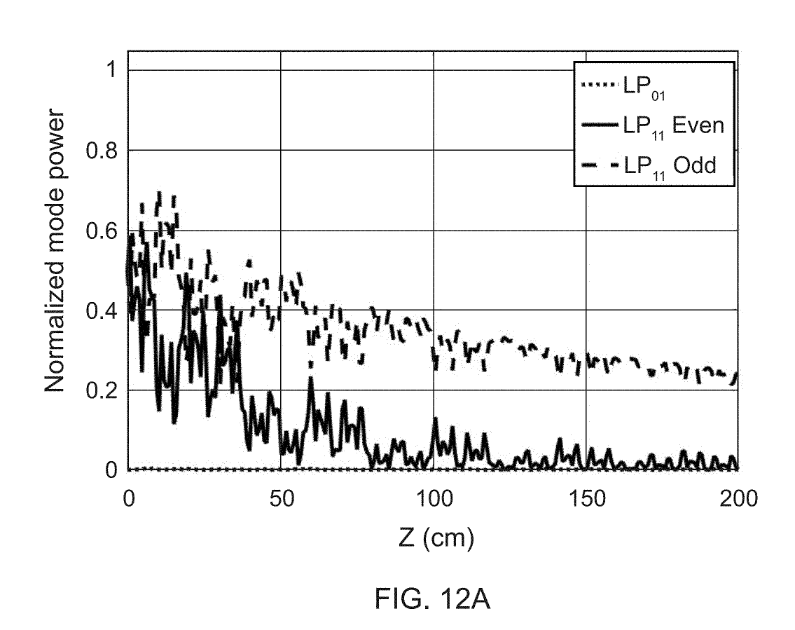

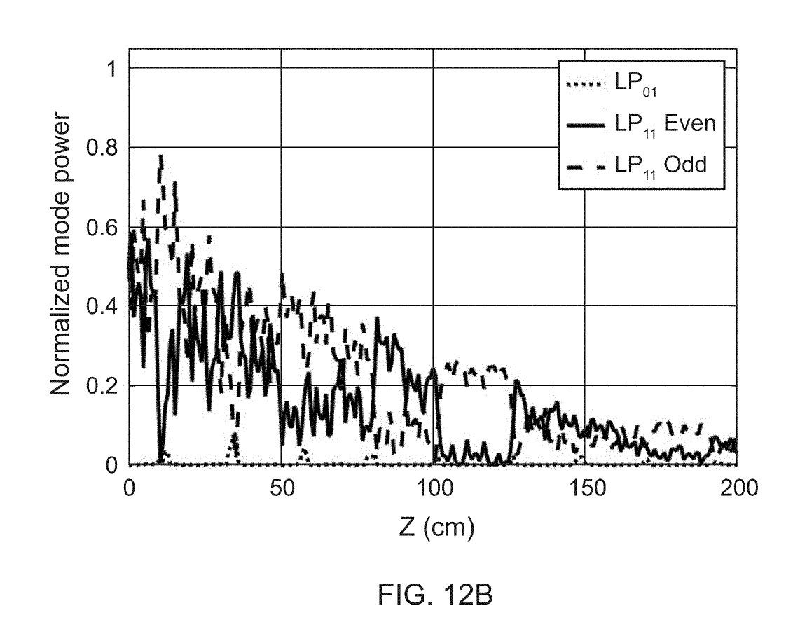

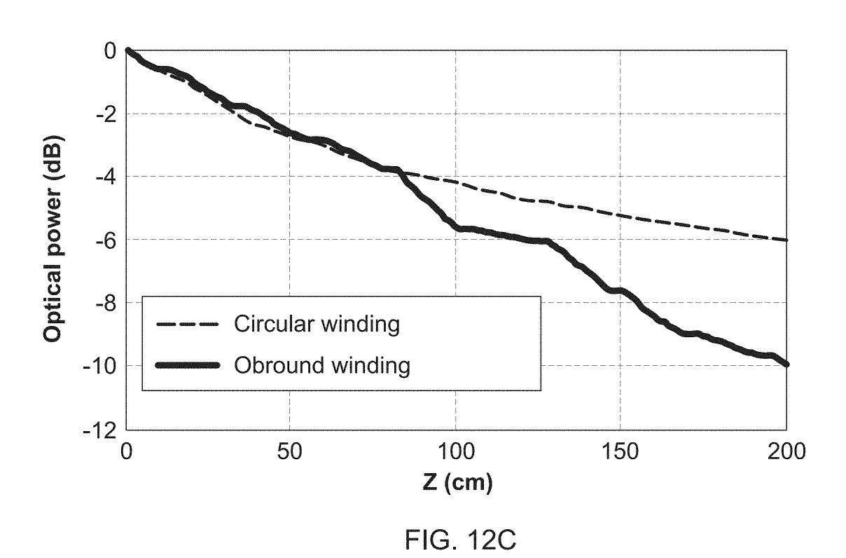

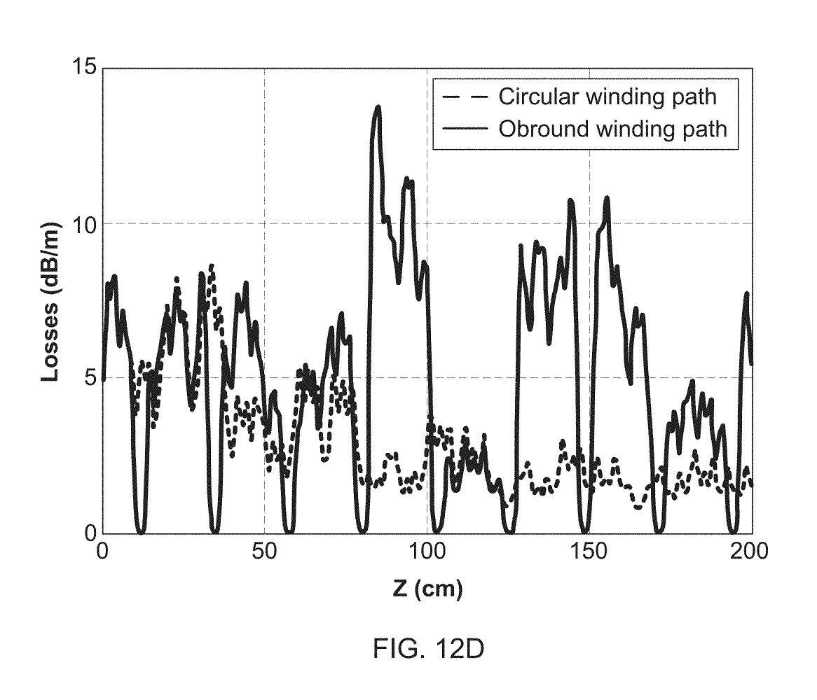

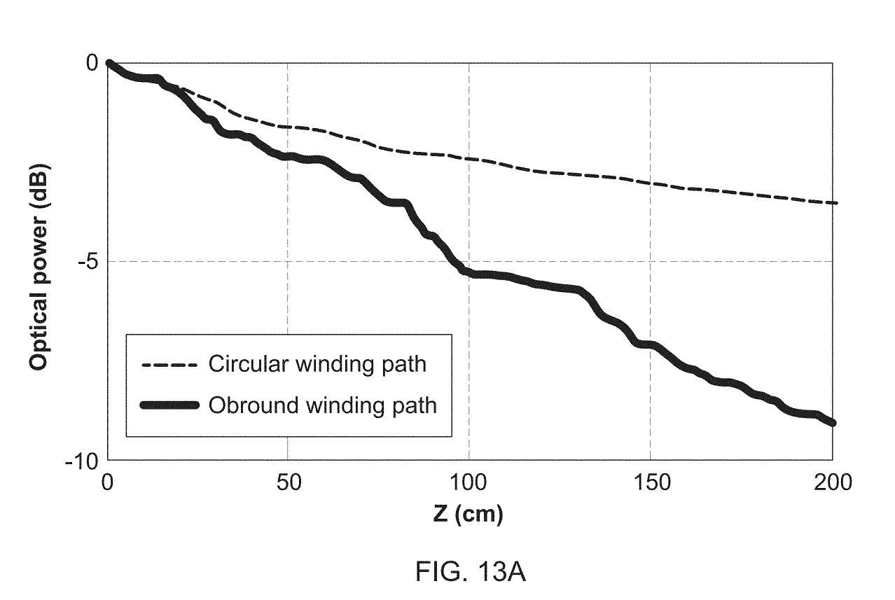

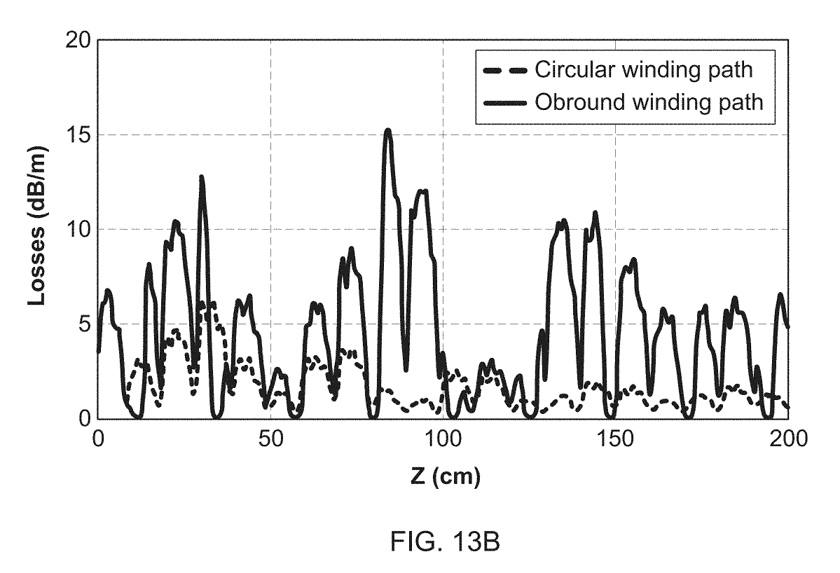

Numerical calculations illustrating the benefit of winding a spun LMA fiber along a non-circular winding path rather than a circular winding path to enhance filtering of higher-order modes will now be described while referring to FIGS. 12A to 12D for a non-PM LMA fiber, and to FIGS. 13A and 13B for a PM LMA fiber. It is emphasized that the present techniques are not limited to these specific numerical simulations.

FIGS. 12A to 12D consider the case of an optical fiber assembly including a non-PM LMA fiber having a slightly elliptical core (core area: about 850 μm²; core circularity: 0.95) and a spin imparted thereto (spin pitch: 20 cm). FIGS. 12A and 12B show numerical simulations of the evolution of the normalized mode power of the fundamental mode LP₀₁, the even LP₁₁ mode and the odd LP₁₁ mode. Each curve is plotted as a function of propagation distance in the case of a circular winding path (FIG. 12A; bending radius: 5.5 cm) and an obround winding path (FIG. 12B; length of straight segments: 5 cm, bending radius of semicircular segments: 5.5 cm). In both cases, the optical beam injected in the fiber excites the LP₁₁ mode group with equal power in the even and the odd mode orientations. It is noted that a passive fiber is considered in FIGS. 12A to 12D to better illustrate the benefits of an obround winding path for enhancing filtering efficiency of higher-order modes.

FIG. 12A shows that the bending losses for the odd LP₁₁ mode are significantly smaller than those of the even LP₁₁ mode. This indicates that, in this implementation, a spun optical fiber wound along a circular winding path is less effective in filtering out the odd LP₁₁ mode than it is in filtering out the even LP₁₁ mode. In contrast, FIG. 12B shows that the bending losses are similar and relatively high for both the even and the odd LP₁₁ modes, indicating that, in this implementation, a spun non-PM optical fiber wound along an obround winding path provides an effective way to suppress both the even and the odd LP₁₁ modes. It is noted that FIG. 16 shows an exemplary embodiment of an optical fiber assembly 20 including a spun non-PM fiber 22 wound around a winding support 24 along an obround winding path 46. FIGS. 12C and 12D show curves of the total optical power (FIG. 12C; normalized to the input optical power) and bending loss curves (FIG. 12D), each plotted as a function of propagation distance for the obround winding path (solid lines) and the circular winding path (dashed lines). Again, it is seen that a non-circular winding path with straight segments can provide enhanced filtering of higher-order modes compared with a strictly circular winding path.

FIGS. 13A and 13B consider the case of a fiber assembly including a passive PM fiber having a spin imparted thereto (core area: about 850 μm²; core circularity: 0.95; spin pitch: 20 cm). As in FIGS. 12C and 12D, FIGS. 13A and 13B show total optical power curves (FIG. 13A) and bending loss curves (FIG. 13B), each plotted as a function of propagation distance for an obround non-circular winding path (solid lines; length of straight segments: 5 cm, bending radius of semicircular segments: 5.5 cm) and a circular winding path (dashed lines; bending radius: 5.5 cm). The optical beam launched into the spun PM fiber excites the LP₁₁ mode group with equal power in the even and the odd mode orientations. It is seen from FIGS. 13A and 13B that a non-circular winding path can also enhance the filtering of higher-order modes in a PM fiber compared with a circular winding path. It is also seen that for the parameters used in the numerical simulations shown in FIGS. 12A to 12D and FIGS. 13A and 13B, the improvement in the filtering efficiency of the LP₁₁ modes is even larger for the case of the PM fiber.

Of course, numerous modifications could be made to the embodiments described above without departing from the scope of the appended claims.

1. An optical fiber assembly for higher-order-mode filtering, the optical fiber assembly comprising:
a winding support; and
an optical fiber configured to support a fundamental transverse mode and one or more higher-order transverse modes, the optical fiber having a longitudinal fiber axis, a core, a cladding surrounding the core, a transverse cross-section having at least one characteristic lacking circular symmetry, and a rotation imparted thereto about the longitudinal fiber axis with a spatial repetition period, the optical fiber being wound on the winding support along a winding path having a non-constant radius of curvature, the rotation and winding of the optical fiber providing stronger attenuation of the one or more higher-order transverse modes as compared to the fundamental transverse mode.

2. The optical fiber assembly of claim 1, wherein the winding path comprises a plurality of turns on the winding support, each one of the turns comprising at least one first segment having a first length and a first radius of curvature and at least one second segment having a second length and a second radius of curvature larger than the first radius of curvature.

3. The optical fiber assembly of claim 1, wherein the winding path comprises a plurality of turns on the winding support, each one of the turns having an obround shape consisting of two semi-circular segments connected at respective endpoints thereof by two straight segments parallel to each other.

4. The optical fiber assembly of claim 3, wherein a ratio of the length of the straight segments to the spatial repetition period is selected such that the one or more higher-order transverse modes undergo an odd integer number of 90° rotations upon propagation along each straight segment.

5. The optical fiber assembly of claim 1, wherein the spatial repetition period ranges from 1 centimeter to 50 centimeters.

6. The optical fiber assembly of claim 1, wherein the core has a diameter larger than 30 micrometers.

7. The optical fiber assembly of claim 1, wherein the optical fiber further comprises at least one stress-applying part enclosed within the cladding and arranged about the core.

8. The optical fiber assembly of claim 7, wherein the optical fiber has an unspun polarization beat length shorter than the spatial repetition period.

9. The optical fiber assembly of claim 1, wherein the rotation imparted to the optical fiber results from a permanent spin impressed on the optical fiber.

10. The optical fiber assembly of claim 1, wherein the core has an elliptical transverse cross-section with a major cross-sectional axis and a minor cross-sectional axis, a ratio of the minor cross-sectional axis to the major cross-sectional axis being greater than 0.95 and less than 1.

11. An optical fiber assembly for higher-order-mode filtering, the optical fiber assembly comprising:
a winding support; and
an optical fiber configured to support a fundamental transverse mode and one or more higher-order transverse modes, the optical fiber having a longitudinal fiber axis, a core having a diameter larger than 10 micrometers, a cladding surrounding the core, at least one stress-applying part enclosed within the cladding and arranged about the core, and a rotation imparted thereto about the longitudinal fiber axis with a spatial repetition period, the optical fiber being wound on the winding support along a winding path, the rotation and winding of the optical fiber providing stronger attenuation of the one or more higher-order transverse modes as compared to the fundamental transverse mode.

12. The optical fiber assembly of claim 11, wherein the at least one stress-applying part consists of a pair of stress-applying parts extending along diametrically opposed helical paths about the core.

13. The optical fiber assembly of claim 11, wherein the spatial repetition period ranges from 1 centimeter to 50 centimeters.

14. The optical fiber assembly of claim 11, wherein the optical fiber has an unspun polarization beat length shorter than the spatial repetition period.

15. The optical fiber assembly of claim 11, wherein the rotation imparted to the optical fiber results from a permanent spin impressed on the optical fiber.

16. A method for higher-order-mode filtering, comprising:
providing an optical fiber configured to support a fundamental transverse mode and one or more higher-order transverse modes, the optical fiber having a longitudinal fiber axis, a core, a cladding surrounding the core, a transverse cross-section having at least one characteristic lacking circular symmetry, and a rotation imparted about the longitudinal fiber axis with a spatial repetition period, the optical fiber being wound along a winding path having a non-constant radius of curvature; and
injecting a light signal into the optical fiber for propagation thereinside in the fundamental transverse mode and the one or more higher-order transverse modes, the rotation and winding of the optical fiber providing stronger attenuation of the one or more higher-order transverse modes as compared to the fundamental transverse mode as the light signal propagates in the optical fiber.

17. The method of claim 16, wherein the winding path comprises a plurality of turns, each one of the turns having at least one first segment having a first length and a first radius of curvature and at least one second segment having a second length and a second radius of curvature larger than the first radius of curvature, the method further comprising selecting the second length in accordance with the spatial repetition period.

18. The method of claim 16, wherein the winding path comprises a plurality of turns, each one of the turns having an obround shape consisting of two semi-circular segments connected at respective endpoints thereof by two straight segments parallel to each other, the method further comprising selecting a length of the straight segments in accordance with the spatial repetition period.

19. The method of claim 18, wherein said selecting comprises determining a ratio of the length of the straight segments to the spatial repetition period that causes the one or more higher-order transverse modes to undergo an odd integer number of 90° rotations upon propagation along each straight segment.

20. A method for higher-order-mode filtering, comprising:
providing an optical fiber wound along a winding path and configured to support a fundamental transverse mode and one or more higher-order transverse modes, the optical fiber having a longitudinal fiber axis, a core having a diameter larger than 10 micrometers, a cladding surrounding the core, at least one stress-applying part enclosed within the cladding and arranged about the core, and a rotation imparted about the longitudinal fiber axis with a spatial repetition period; and
injecting a light signal into the optical fiber for propagation thereinside in the fundamental transverse mode and the one or more higher-order transverse modes, the rotation and winding of the optical fiber providing stronger attenuation of the one or more higher-order transverse modes as compared to the fundamental transverse mode as the light signal propagates in the optical fiber.
